(19) United States
(12) Patent Application Publication
(10) Pub. No.: US 2010/0042453 A1
(43) Pub. Date: Feb. 18, 2010

(54) Methods and apparatus for greenhouse gas footprint monitoring

(75) Inventors: Thomas Joseph Scaramellino, New York, NY (US); Ezekiel Jon Hausfather, Brooklyn, NY (US)

Correspondence Address: Lipsitz & McAllister, LLC, 755 MAIN STREET, MONROE, CT, 06468, US

(73) Assignee: Efficiency 2.0, LLC., New York, NY (US)

(21) Appl. No.: 12/462,859

(22) Filed: Aug. 10, 2009

Related U.S. Application Data
(60) Provisional application No. 61/188,817, filed on Aug. 12, 2008.

(51) Int. Cl. G06Q 10/00; G06Q 99/00

(52) U.S. Cl. 705/7; 705/1

(57) ABSTRACT

The present invention invention provides methods, apparatus, and systems for determining greenhouse gas (including carbon dioxide) emissions and energy usage, costs and savings of individuals, families, homes, buildings, businesses, or the like. User inputs specific to an end user are accepted, and one or more of the user inputs are correlated with at least one of historic data and modeled characteristics pertaining to greenhouse gas emissions and energy usage to obtain at least one of greenhouse gas emissions and energy usage corresponding to said one or more of said user inputs. An overall greenhouse gas emissions and energy usage can then be determined for the end user based on the greenhouse emissions and energy usage corresponding to the one or more of the user inputs. A specific impact of a particular user action on the end user's overall greenhouse gas emissions and energy usage may also be calculated.

This application claims the benefit of U.S. Provisional Patent Application No. 61/188,817, filed Aug. 12, 2008, which is incorporated herein and made a part hereof by reference.

### BACKGROUND OF THE INVENTION

The present invention relates to the field of greenhouse gas emissions and energy usage. More specifically, the present invention provides methods, apparatus, and systems for determining the greenhouse gas emissions and energy usage, as well as associated dollar costs and savings of individuals, families, homes, buildings, businesses, or the like. The present invention also provides methods, apparatus, and systems for determining the impact of particular actions on overall greenhouse gas emissions and/or energy usage.

With increasing energy costs and growing concern about global warming, individuals and companies have become increasingly concerned with their impact on the environment and in particular their contribution to climate change. An individual or organization's impact on or contribution to climate change has come to be known as a “carbon footprint”. The term “carbon footprint” as used herein should be understood to include greenhouse gases in addition to carbon dioxide.

There are several prior art carbon footprint calculators, such as Yahoo! Green or An Inconvenient Truth Calculator, which yield outputs that apply across individuals in a particular zip code, state or even nation. However, these prior art calculators are unable to provide a carbon footprint determination that is uniquely tailored to a specific individual or business. Further, none of the available prior art calculators is capable of determining changes in the carbon footprint based on new or proposed actions taken or contemplated by an individual or a business at a high resolution and personalized degree of specificity.

It would be advantageous to provide accurate estimates of carbon dioxide emissions and energy usage that apply specifically to an individual, family, business, home or building. It would also be advantageous to determine the impact that specific actions or proposed actions would have on the determined estimates, so that the relative impact of the action on global warming can be determined.

The methods, apparatus, and systems of the present invention provide the foregoing and other advantages.

### SUMMARY OF THE INVENTION

The present invention relates to methods, apparatus, and systems for determining greenhouse gas (including carbon dioxide) emissions and energy usage, costs and savings of individuals, families, homes, buildings, businesses, or the like. Although the present invention is described below in connection with the determination of an individual's carbon footprint, those skilled in the art will appreciate that the present invention can be applied to families, homes, buildings, businesses, or the like and may be include a wide variety of resources, energy systems and greenhouse gases.

The present invention, developed by Efficiency 2.0, LLC of New York (formerly Climate Culture, LLC), includes four major components:

1. Energy Mapping Software (EMS)—determines an individual's energy use and greenhouse gas footprint based on a variety of forms of data and algorithms. The EMS provides a comprehensive, personalized and granular estimate of an individual's energy use, greenhouse gas (including carbon dioxide) emissions, and other greenhouse gas emissions (including methane, nitrous oxide, and various halocarbons) across areas including (but not limited to) home, work, travel, recreation, dining, and shopping habits, including resource usage, direct and indirect energy usage and greenhouse gas emissions.

2. Personal Energy Advisor—determines the change (or potential change) in energy use and greenhouse gas emissions, as well as the dollar cost, dollar savings, and other resource savings based on a change in an individual's actions and purchases (or potential actions and purchases) from the entire scope of behavioral and purchasing decisions individuals and businesses confront in their ordinary lives and business operations, respectively.

3. Community Connect—combines the Energy Mapping Software and Personal Energy Advisor to create a personalized and automated online assistant capable of helping an individual or business understand its specific impact on global warming, energy supply, and other resources through lifestyle habits, actions taken and purchases made. Community Connect also integrates the energy advisory service with online community features that enable individuals to compare and compete with others in a host of sophisticated ways.

4. Climate Culture Virtual World Game and Social Network (CCVW)—is a virtual networked environment that mirrors the actual global warming impact of the individual and those in the individual's social network community. The Climate Culture Virtual World Game creates a new process for enabling a consumer or organization to understand and decrease its global warming impact. The Climate Culture Virtual World Game accomplishes this goal by enabling users to engage one another in a competitive and collaborate virtual space. The Climate Culture Virtual World Game is a game aimed at consumers and businesses which enables them to reduce their global warming impact by providing reliable estimates of carbon dioxide and energy usage, as well as associated reductions in usage.

In accordance with one example embodiment of the present invention, a computerized method for determining greenhouse gas emissions and energy usage is provided. User inputs specific to an end user are accepted, and one or more of the user inputs are correlated with at least one of historic data and modeled characteristics pertaining to greenhouse gas emissions and energy usage to obtain at least one of greenhouse gas emissions and energy usage corresponding to the one or more of the user inputs. Overall greenhouse gas emissions and energy usage can then be determined for the end user based on the greenhouse emissions and energy usage corresponding to the one or more of the user inputs.

Note it should be appreciated that the term “end user” is used herein to include any individual, group of individuals, entity, business, non-profit company, university, and the like, including any other “user” that may have a carbon footprint.

The user inputs may comprise details regarding at least one of home, work, travel, and consumption of goods.

In one example embodiment, the overall greenhouse gas emissions and energy usage may comprise direct and indirect greenhouse gas emissions and energy usage. The direct greenhouse gas emissions and energy usage account for a direct impact of at least one of actions taken by the end user and performance of products purchased by the end user. The indirect greenhouse gas emissions and energy usage corresponds to one or more of material sourcing, manufacture, distribution, retail, consumption and post-consumption of products purchased by the end user.

Home, work, shopping and travel categories of greenhouse gas emissions and energy usage may be provided. The end user may be enabled to make a selection of one or more of the categories, such that a portion of the overall greenhouse gas emissions and energy usage corresponding to the one or more selected categories can be determined. The portion of the overall greenhouse gas emissions and energy usage for the home category may be based on at least one of water heating, space heating, space cooling, appliance information, and the like for the end user's home. The portion of the overall greenhouse gas emissions and energy usage for the work category may be based on at least one of electricity and natural gas information (and optionally additional information as discussed below) for the end user's work environment. The portion of the overall greenhouse gas emissions and energy usage for the shopping category may be based on at least one of food, alcohol, hotel, housing, healthcare, and miscellaneous expenditures and consumption information, and the like. The portion of the overall greenhouse gas emissions and energy usage for the travel category may be based on at least one of vehicle, airplane, and miscellaneous transportation expenditures and information, and the like.

The user inputs for the home category may comprise at least one of zip code, heating equipment type, cooling equipment type, heating fuel, water heater type, water heater size, water heater fuel, space heating equipment, space cooling equipment, age of heating and cooling equipment, residence type, residence construction material information, year of residence construction, square footage, number of rooms, number of heating degree days per year, number of cooling degree days per year, yearly household income, lighting type and usage information, home office equipment information, major appliance information, small appliance information, day and night thermostat settings, census division based on zip code, typical temperature setting for wash cycle of washing machine, stove fuel, number of people in residence, average monthly fuel usage, average monthly fuel cost, swimming pool information, spa information, number of televisions, number of computers, relative urbanity of area of home, aquarium information, separate freezer, water bed ownership characteristics, and the like.

In one example embodiment, the zip code input may be linked to a corresponding weather location. Energy usage corresponding to a default residence type for the corresponding weather location may be determined based on historical weather patterns for that weather location. The overall greenhouse gas emissions and energy usage may then be determined from the energy usage corresponding to the default residence type.

The zip code input may be mapped to a regression analysis of at least one of current Department of Energy Residential Energy Consumption Survey data, National Climate Data Center Climate Division data, U.S. Census Data, American Housing Survey Data, public energy consumption data, private energy consumption data, and the like.

In addition, specific residence information may be automatically obtained from computerized public records. The default residence type may be refined based on the specific residence information obtained in this manner. The specific residence information may include at least one of residence type, square footage, year built, heating equipment type, cooling equipment type, fuel type, insulation type, number of rooms, number of individuals in residence, and the like.

The overall greenhouse gas emissions and energy usage corresponding to the default residence type may be modified based on other of the user inputs.

The overall greenhouse gas emissions and energy usage may be subdivided into a plurality of home end-uses and an overall home footprint.

The user inputs for the home category may include home fuel payment information. The fuel payment information may comprise fuel cost information. Where such fuel cost information is provided, this fuel cost information may be correlated with a utility provider based on a database of utility providers for the end user's zip code. Up-to-date pricing information may then be obtained for the utility provider, and the fuel usage can then be determined based on this pricing information.

The fuel payment information may be obtained automatically from online banking records or utility records.

In an alternate embodiment, the fuel payment information may be linked to a database containing annual fuel use curves for a corresponding fuel type used in the residence. The annual fuel use curve may be determined from historical weather and temperature characteristics in a weather location corresponding to the zip code.

In a further alternate embodiment, fuel usage may be determined by a simulation of fuel usage based on the zip code and at least one of the residence type, the heating equipment type, the cooling equipment type, the water heater type, the space heating equipment, the space cooling equipment, the major appliances, the small appliances, and the like. Default inputs may be provided for at least one of the residence type, the heating equipment type, the cooling equipment type, the water heater type, the space heating equipment, the space cooling equipment, the major appliances, the small appliances, and the like. These default inputs may be based on common types of equipment in the weather location.

The user inputs for the travel category may comprise at least one of vehicle information, flight history information, vehicle rental information, taxi usage history, public transportation usage habits, and the like. Yearly fuel consumption for each vehicle identified in the vehicle information may be determined based on one of historical mileage data or user input actual mileage data for each of the identified vehicles. The yearly fuel consumption may then be converted to yearly greenhouse gas emissions for each vehicle using conversion factors for converting fuel type to carbon dioxide.

The flight history information may comprise one of: (a) specific flight information for each flight taken, including at least one of flight length, flight origin and destination, plane type, plane age, layover information, and the like; and (b) estimate of number of flights taken and length of flights taken. A flight class may be determined for each flight based on the flight length. Carbon dioxide emissions may then be determined for each flight based on an emissions factor for the flight class and the flight length.

The user inputs for the work category may comprise at least one of city, state, zip code, square footage, date of construction, number of floors, human capacity and usage, occupation, hours of operation, exterior materials, lighting, heating equipment type, space heating equipment type, cooling equipment type, space cooling equipment type, heating fuel, water heater type, water heater fuel, average monthly fuel usage, fuel usage per month, fuel payment history, electricity usage per month, average electricity usage per month, and the like.

The user input may further comprise one of home office, manufacturing, non-manufacturing, and educational. In the event of an entry of the non-manufacturing user input, a building type user input may be selected from one of: school; supermarket or grocery store; restaurant; hospital; doctor or dentist office; hotel or motel; retail store; professional or administrative office; social space; police or fire department; place of religious worship; post office or copy center; dry cleaners, laundromat or beauty parlor; auto service or gas station; and warehouse or storage facility. Per worker electricity and fuel usage corresponding to a selected building type may be determined, at least in part, from historical energy consumption survey data.

In the event of an entry of the manufacturing user input, a manufacturing sector user input may be selected from one of: food; beverage and tobacco products; textile mills; textile product mills; apparel; leather products; wood products; paper; printing-related support; petroleum and coal products; chemicals; plastics and rubber products; nonmetallic mineral products; primary metals; fabricated metal products; machinery; computer and electronic products; electrical equipment; transportation equipment; furniture and related products; and miscellaneous products. At least one of total fuel consumption, per worker fuel consumption, total electricity consumption, and total natural gas consumption corresponding to a selected manufacturing sector may be determined, at least in part, based on a historical census data for the selected manufacturing sector and geographic location data.

In addition, industry specific user inputs corresponding to the manufacturing user inputs may be made available. The at least one of the total fuel consumption, the per worker fuel consumption, the total electricity consumption, and the total natural gas consumption corresponding to the selected manufacturing sector is refined based on the industry specific user inputs.

In the event of an entry of the educational user input, an educational capacity user input may be selected from one of a teacher input or a student input and a facility type may be selected from one of kindergarten, elementary school, middle school, high school, or college. In determining overall greenhouse gas emissions and fuel usage corresponding to the educational user input, different multiplication factors are assigned based on whether the teacher user input or the student user input are selected. For example, a first multiplication factor for the teacher user input and the college user input may be based on a per worker value, while a second multiplication factor for the kindergarten user input, the elementary school user input, the middle school user input, and the high school user input may be based on a per worker and student value, such that the overall greenhouse gas emissions and fuel usage per kindergarten, elementary school, middle school or high school student for a selected facility type will be less than the overall greenhouse gas emissions and fuel usage per teacher or college student in the selected facility type.

Further, the educational user inputs may be correlated with historical data for similar educational buildings in a corresponding census division or zip code. Additional user inputs may comprise at least one of city, state, zip code, square footage, date of construction, number of floors, human capacity and usage, occupation, hours of operation, exterior materials, lighting, heating equipment type, space heating equipment type, cooling equipment type, space cooling equipment type, heating fuel, water heater type, water heater fuel, average monthly fuel usage, fuel usage per month, fuel payment history, electricity usage per month, average electricity usage per month, and the like.

The user inputs for the shopping category may comprise at least one of: food and beverage purchase information; household item purchase information; residence information; apparel purchase information; service purchase information; transportation and vehicle usage information; healthcare information; entertainment purchase information; personal care product and service purchase information; reading material purchase information; educational information; tobacco products and smoking supply purchase information; miscellaneous purchase information; and personal insurance and pension information. The user inputs may be correlated with historical survey data and reference categories for determination of corresponding multiplication factors. Dollars spent for each of the user inputs may then be multiplied with a corresponding multiplication factor to determine corresponding greenhouse gas emissions and energy usage for each of the user inputs.

The energy usage may be converted to greenhouse gas emissions using historical sub-regional grid-level electricity greenhouse gas content data.

The historic data may comprises at least one of government data, private data, public energy study data, data contained in databases administered by universities and government agencies, and the like. For example, the government data may comprise data from at least one of U.S. Department of Energy, U.S. Environmental Protection Agency, U.S. Department of Labor, U.S. Department of Commerce, U.S. Department of Transportation, U.S. Census Bureau, and data from databases maintained by other government agencies.

In a further example embodiment of the present invention, the end user may be prompted for additional user inputs based on selected user inputs to further refine the overall greenhouse gas emissions and energy usage.

In another example embodiment, a specific impact of a particular user action on the end user's overall greenhouse gas emissions and energy usage may be calculated. The impact may be presented in the form of at least one of energy savings or increase, greenhouse gas reduction or increase, cost savings or increase, and resource savings or increase for the particular user action. In addition, comparisons of the impact between alternate choices for a particular user action may be provided.

The overall greenhouse gas emissions and energy usage for the end user may be updated automatically upon entry of a particular user action.

At least one of an Internet application or a downloadable application may be provided for at least one of: (a) the determining of the overall greenhouse gas emissions and energy usage for the end user; and (b) the calculating of the specific impact of a particular user action or purchase.

A customizable user interface may be provided for at least one of the Internet application and the downloadable application. At least one of the Internet application and the downloadable application may be adapted to run on a cellular phone, a personal digital assistant, a laptop computer, a desktop computer, a netbook, or the like.

In a further example embodiment, a link to at least one of selected individuals or selected companies may be provided for comparison of overall greenhouse gas emissions and energy usage.

In addition, the present invention may provide at least one of: updates on the selected individuals or companies greenhouse gas emissions and energy usage status; real-time chats with the selected individuals or individuals at the selected companies; energy saving product and service updates; energy and cost savings planning information; fuel cost updates from various regional suppliers, informational material regarding energy savings and reduction of greenhouse gas emissions; community event information; online shopping for recommended products and services; displays relating to the overall greenhouse gas emissions and energy usage and subcategories of the overall greenhouse gas emissions and energy usage; access to custom product and action recommendations tailored to the end user based on the user inputs; energy saving actions recommended based on actions taken by users with similar demographic characteristics; energy savings actions prioritized based on payback period and discount rate, and similar features and functionality.

In another example embodiment, a virtual world environment may be provided for the end user based on the user inputs. A calculation of a specific impact of a particular user action taken in the virtual world environment on the end user's overall greenhouse gas emissions and energy usage may be made. Guidance and recommendations to the end user for reducing the overall greenhouse gas emissions and energy usage in the virtual world environment may be provided. Virtual contests between individuals in the virtual world for reduction of the overall greenhouse gas emissions and energy usage in the virtual world environment may be enabled. In addition, a multi-user virtual game where points are awarded based on reduction of the overall greenhouse gas emissions and energy usage in the virtual world environment may also be enabled.

The present invention also includes apparatus and systems for determining greenhouse gas emissions and energy usage. In one system embodiment, a user interface adapted to accept user inputs specific to an end user is provided. A communications link to at least one database is also provided. Processing means adapted to accept the user inputs from the user interface and to access the at least one database via the communications link is also provided. The processing means is adapted to correlate one or more of the user inputs with at least one of historic data and modeled characteristics pertaining to greenhouse gas emissions and energy usage contained in the at least one database to obtain at least one of greenhouse gas emissions and energy usage corresponding to the one or more of the user inputs. The processing means can then determine an overall greenhouse gas emissions and energy usage for the end user based on the greenhouse emissions and energy usage corresponding to the one or more of the user inputs.

The system embodiments may also include the features and functionality discussed above in connection with the methods of the present invention.

### BRIEF DESCRIPTION OF THE DRAWINGS

The present invention will hereinafter be described in conjunction with the appended drawing figures, wherein like reference numerals denote like elements, and:

FIG. 1 shows a simplified block diagram of an example embodiment of a system for implementing the present invention;

FIG. 2 shows a flow diagram of an example embodiment of the Energy Mapping Software provided in accordance with the present invention; and

FIG. 3 shows a flow diagram of an example embodiment of the Personal Energy Advisor Software provided in accordance with the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

The present invention provides methods, apparatus, and systems for greenhouse gas footprint monitoring. More particularly, the present invention provides a comprehensive, high-resolution, and helpful process for quantifying and reducing global warming impact. Global warming impact includes energy use, carbon dioxide emissions, emissions of other greenhouse gases (including methane, nitrous oxide, and halocarbons), and various physical resources. The methods, apparatus, and systems of the present invention maximize the likelihood of an output corresponding with the user's actual output under the widest range of user inputs.

The present invention is comprised of two hierarchically integrated and normalized sets of algorithms. The Energy Mapping Software determines a user's energy and other resource use as well as greenhouse gas emissions based on a range of no more than 5 to more than 100 inputs. The Personal Energy Advisor, which incorporates and builds upon the Energy Mapping Software outputs determines a user's energy and other resource use and greenhouse gas emissions based on hundreds of actions and purchases with thousands of potential inputs. The Personal Energy Advisor also combines the baseline usage estimates from the Energy Mapping Software with the behavioral and purchase modeling estimates, which interact in a complex feedback mechanism by which increased information in one algorithm can evolve the output from the other algorithm through a wide array of intermediate values.

The present invention also makes use of web-based technology to promote real-time energy use and greenhouse gas emissions monitoring. In accordance with an example embodiment of the present invention, the user input may be provided via a user interface presented on a website. The user may login to a private page on the web site and enter inputs in response to various queries, described in detail below. The user may create a user profile and save the input information and resultant calculations, so that they can be easily modified and updated at a later time.

Among other things, the algorithms provided by the present invention manipulate databases maintained by various external sources. The external sources relied on by the present invention include the highest quality, most current government, industry and custom databases. The present invention runs simultaneous algorithms for any given operation to produce no less than 10 discrete outputs per operation from a wide range of default and/or user inputs. The present invention may then recommend actions based on the user's personal preferences, energy use habits, lifestyle characteristics, and the like through a sophisticated recommendation algorithm that takes into account the end user's demographic, psychographic and energy end use profiles.

The present invention displays, translates and builds upon its outputs through a wide variety of interfaces that maximize the likelihood of a user closely relating to the quantity output. User interfaces provided in accordance with the present invention may also be a part of the Community Connect and Climate Culture Virtual World Game and Social Network, which may include a competitive and collaborative interactive social network, a virtual world, interactive maps and visualization layers, complex unit conversions and time tracking.

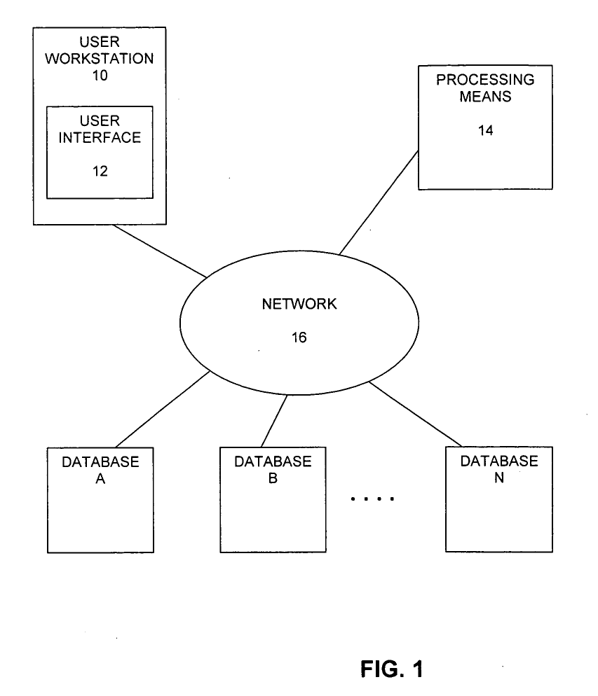

FIG. 1 is a simplified block diagram of an example embodiment of a system for implementing the present invention. A user workstation 10 may be provided with a user interface 12 adapted to accept user inputs specific to an end user. A communications link (e.g., connection via network 16) may be provided to at least one database (e.g., databases A, B, . . . N). Processing means 14 may be provided, which may be adapted to accept the user inputs from the user interface 12 and to access the at least one database A, B, . . . N via the communications link in order to correlate one or more of the user inputs with historic data pertaining to greenhouse gas emissions and energy usage contained in the at least one database, in order to obtain at least one of greenhouse gas emissions and energy usage corresponding to the one or more of the user inputs. The processing means 14 may then determine an overall greenhouse gas emissions and energy usage for the end user based on the greenhouse emissions and energy usage corresponding to the one or more of the user inputs. It should be appreciated that the block diagram of FIG. 1 is simplified for ease of explanation, and that the system may comprise various additional elements and sub-elements as required to carry out the software processes discussed below. For example, the system may comprise a large number of separate user workstations 10, and a large number of databases A, B, . . . N, the network 16 may comprise the Internet, as well as public and private networks, local area networks, wide area networks, and the like. Multiple processing means 14 may be provided which may or may not be in communication with each other. Further, the processing means 14 may include multiple computer processors, Internet servers, storage devices, integrated databases, user profile information storage, credit card processing features, electronic store functionality, and the like.

The individual components of the present invention are described in more detail below.

I. Energy Mapping Software

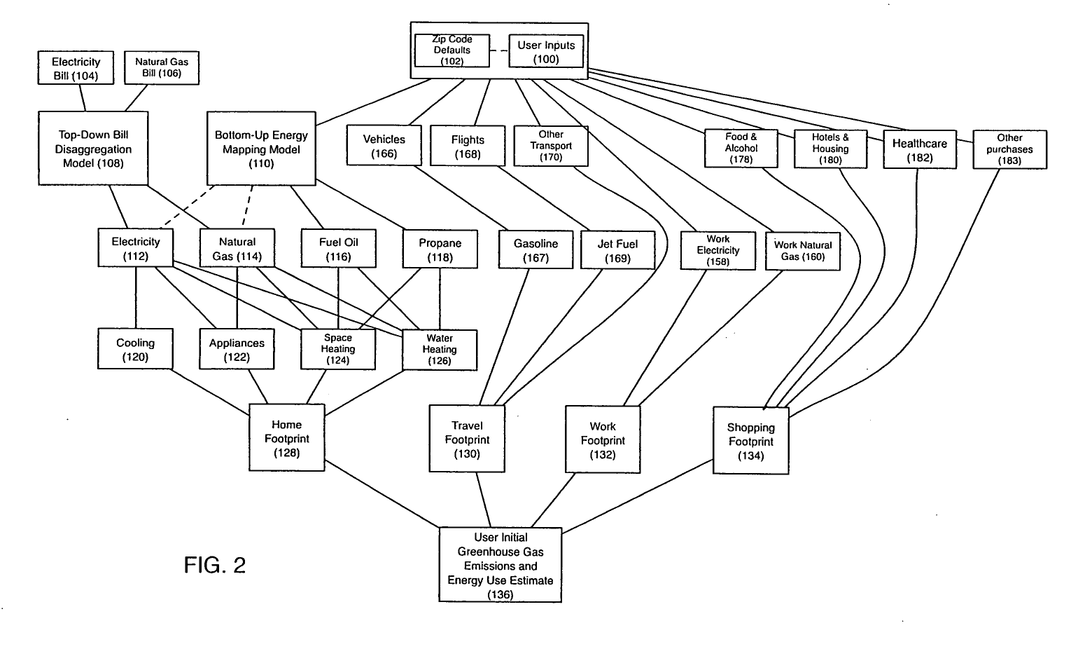

The Energy Mapping Software is an advanced and intuitive personal energy use and greenhouse gas footprint calculator. The software spans a wide range of databases and algorithms that interact to provide a comprehensive and accurate estimate of an individual's greenhouse gas emissions and energy use. A flowchart illustrating an example embodiment of the Energy Mapping Software is shown in FIG. 2, which is explained in more detail below. The processes described in the FIG. 2 flowchart may be implemented on the system shown in FIG. 1.

Referring to FIG. 2, the Energy Mapping software incorporates all aspects of a user's lifestyle, and provides an estimate of overall greenhouse gas emissions and energy usage 136, which includes but is not limited to greenhouse gas emissions and energy usage from the end user's home (Home Footprint 128), travel (Travel Footprint 130), work (Work Footprint 132), and shopping habits (Shopping Footprint 134). The estimates, for example the estimates in each of these four categories—home, work, travel and shopping—span direct carbon dioxide emissions, such as burning gasoline in your car, and indirect emissions, like those associated with manufacturing the products that are bought or with delivering fuel to households. Accordingly, the software incorporates direct and indirect carbon dioxide emissions across the entire range of a user's affect on the climate.

The software is not only a comprehensive carbon footprint calculator but also very granular. For instance, the software is not only capable of estimating a user's home energy and carbon dioxide footprint, but it can also categorize that footprint into various components, for example, space heating, space cooling, water heating, lighting, large appliances, small appliances, and the like. The same level of granularity applies to the other three usage categories as well. The granularity of the software helps a user discern precisely where lifestyle choices most affect energy use and the climate. With this knowledge a user can readily answer a host of interesting questions, like “How does my air conditioner usage in the summer compare to my year-round driving emissions?” Or: “How do the indirect emissions associated with buying groceries compare to those associated with my computer usage at work?” Being able to differentiate the impact of a user's various activities provides the first step towards an understanding of meaningful behavioral changes that may help protect the climate.

Perhaps just as important as the comprehensiveness, accuracy and granularity of the software is the fact that it is also completely customizable to the time and legitimacy budgets of its users. For example, user inputs 100 may include answers to as few as 5 or more than 100 questions to receive a high-resolution footprint estimate that applies exclusively to that end user. The software only requires questions that users can readily answer, and it formats the questions so users can answer in the most convenient way possible. It also guides the user through the process of answering additional questions that provide more refined footprint estimates if the user so chooses, informing the user as to which inputs will have the greatest impact on output accuracy. As a result, the software meets the needs of both ordinary people who are typically strapped for time and the most demanding energy and climate specialists who will settle for nothing less than the most precise estimates possible.

The different components of a user's energy end-use characteristics will be described in more detail below. Those skilled in the art will appreciate that the present invention can be implemented with more or less than the residential, commercial, travel and consumption categories mentioned herein. Similarly, those skilled in the art will appreciate that the present invention can be implemented using different categories or functions to the same effect.

### Home Footprint 128

The home energy use estimation model operates in one of two ways: a Top-Down Bill Disaggregation Model 108 in cases where there is access to user utility bills (e.g., electricity bills 104 and natural gas bills 106), and a Bottom-Up Energy Mapping Model 110 cases where there is not, where specific user inputs 100 and zip code defaults 102 are utilized. In FIG. 2, the dashed lines reflect relationships that may or may not occur based on specific end user characteristics or user inputs 100. In addition, it should be appreciated that outputs for electricity 112 and natural gas 114 from the Top-Down Bill Disaggregation Model 108 supersede those of the Bottom-Up Energy Mapping Model 110 when available.

### Bottom-Up Energy Mapping Model 110

To produce a viable personalized energy use calculation in the absence of available utility bills or user inputs, the energy use mapping software employs a Bottom-Up Model 110 to estimate the mode household energy use for space heating 124, cooling 120, water heating 126, and appliances 122 for every zip code in the country. This energy mapping software is based on a multivariate regression analysis of the most recent Department of Energy Residential Energy Consumption Survey (RECS) data to identify factors significant in determining total energy use for each category. The model identified 13 significant variables predicting 84 percent of the variability in home heating energy use (e.g., r2=0.84). Similarly, the model used 8 significant variables to predict 61 percent of the variability in home water heating energy use, 9 significant variables to predict 73 percent of the variability in home cooling energy use, and 23 significant variables to predict 62 percent of the variability in home appliance energy use.

The resulting regression functions were applied to every zip code using granular default values for every significant variable obtained from the U.S. Census, further regressions on RECS data for variables not available in census data, a network of 345 geographically distributed weather stations, insolation data for every zip code from the National Renewable Energy Laboratory, NERC subregion emissions factors from the EPA's e-Grid program, state-level transmission loss data from the DoE's Energy Information Agency (EIA), and a number of other sources. Results were independently validated by multiplying estimated median household energy use by fuel type by the number of housing units in each zip code and comparing the results on both the state and national level to residential electricity, natural gas, and fuel oil consumption statistics from the EIA.

This approach provides a reasonable idea of the most common home energy use, fuel type, and appliance use characteristics simply based on the user's zip code. Each variable is given a zip default value by the model (e.g., zip code defaults 102). Additionally, a number of variables (house type, square footage, year built) may be automatically accessed from county records given the user's home address (e.g., via processing means 14 accessing the appropriate database A, B, . . . N via a network 16 as shown in FIG. 1).

User inputs 100 can be provided for the actual values for all variables by answering a number of questions about the end user's home, and these values replace the zip code-based defaults 102. The variables that the users can input include but are not limited to: home type (house, mobile home, dorm, small apartment, large apartment, condominium, and the like), total number of rooms, number of heating degree days (base 65) based on the nearest available weather station to the user's zip code, number of cooling degree days (base 65) based on the nearest available weather station to the user's zip code, total combined household income in the past 12 months, number of people in the household, water heater fuel (electricity 112, natural gas 114, fuel oil 116, or propane 118), water heater size, user does or does not have a dishwasher, user does or does not have a clothes washer, temperature setting for wash cycle of the clothes washer, the year the house was built, total square footage of the house, is someone at home all day on a typical weekday?, thermostat setting during the day when someone is home, thermostat setting during the day when no one is home, census division in which the house is located (based on zip code), age of the main heating equipment, home heating fuel (electricity 112, natural gas 114, fuel oil 116, or propane 118), material of the house's exterior wall, urban/rural characteristics of the user's location, the type of air conditioning system(s), number of rooms cooled by ac, stove fuel (natural gas 114, electricity 112, or propane 118), number of indoor lights that are on more than 12 hours a day, number of indoor lights that are on 4 to 12 hours a day, number of indoor lights that are on 1 to 4 hours a day, presence of outdoor lights, presence of a separate freezer, presence of a dishwasher, presence of a clothes dryer, presence of a heated water bed, number of TV sets, presence of a aquarium, cell phone, personal computer, fax machine, number of refrigerators, age of the main refrigerator, presence of a heated pool, and the like.

This information from users will replace the zip code default values 102 that are obtained from the Census data or that are estimated from the approach described above. The inputs 100 will be plugged into the regression model, providing more granular user-specific energy use estimations. Even when users don't provide specific information, the present invention is still able to estimate energy consumption with already constructed default values 102 set for each zip code region.

Further details regarding the operation of the Bottom-Up Energy Mapping Model 110 and regression models for each energy end-use are provided below.

### Top-Down Bill Disaggregation Model 108

In cases where there is access to billing data, a Top-Down Bill Disaggregation Model 108 is used. Instead of inferring how much energy is used in home heating, cooling, water heating, and appliances based on home characteristics alone (as is done with the Bottom-Up Energy Mapping Model 110 described above), the present invention may alternatively use home characteristics to disaggregate the provided bills into the four major use categories through a methodology adapted from that used in producing the RECS category estimates.

To disaggregate bills into end-use categories, the bills provided in dollars must first be translated into kilowatt hours, therms of natural gas, and gallons of fuel oil used (e.g., by the processing means 14 of FIG. 1). This requires up-to-date energy price data for each user. For electricity, since this differs on the utility level, a way is needed to assign each user to a specific utility. Therefore, a database (e.g., one of databases A, B, . . . N of FIG. 1) of all of the utilities serving each zip code in the country was created, and a list of potential utilities for each user can be populated based on their home zip code. When a user selects a utility, the system is able to look up the latest monthly rate when it is available (as the Department of Energy's Energy Information Agency (EIA) only publishes monthly rates for about 500 of the 3500 utilities in the country, though they include most of the largest regulated ones). If a monthly rate is not available for the user's specific utility in the past three months, the system use the latest monthly average rate for the user's state as a proxy. For natural gas and fuel oil, state-level price data is taken from the EIA for the latest month.

Using energy bills is somewhat complicated due to potentially strong annual variation in home energy use. While this is not a serious issue when a full year of past energy bills are available and input into the system, this may not always be the case, especially for users who have recently moved or when users are manually inputting bills instead of simply providing their utility account number so that the billing history can be electronically accessed. The present invention includes a smart bill calculator that requires only a single month's bill to be input (though it allows for multiple months) and, based on the user's state of residence and heating and cooling equipment and fuel types, estimates annual electricity, natural gas, and/or fuel oil use. For example, a user with a window AC unit that lives in Texas would likely have higher summer electricity use than winter electricity use, and the smart bill calculator takes this (and other factors) into account when estimating the annual bill if the user inputs a summer month. Likewise, a user with a natural gas furnace in, say, New York would have up to an order of magnitude larger natural gas use in the winter than in the summer, and a large natural gas bill during the winter would yield a reasonable annual use estimate based on the model.

### Carbon Emissions Calculations

Because local generation sources are connected to the larger grid, it is impractical to determine an individual's electricity fuel mix based on their proximity to specific generators. Rather, the footprint calculator uses NERC subregion level emission factors based on fuel mix and generation efficiency data from the EPA's eGRID. Emission factors also include transmission losses based on data from the EIA and indirect emissions associated with the fuel-cycle, plant construction, and plant decommissioning of natural gas, nuclear, oil, coal, solar, wind, biomass, geothermal, and hydro. Estimates of fuel cycle and plant construction and decommissioning emissions are based on P. J. Meier's “Life-Cycle Assessment of Electricity Generation Systems and Applications for Climate Change Policy Analysis” (2003). Direct emissions from home natural gas and fuel oil use are calculated based on emission factors from the EPA and estimated fuel-cycle emissions from Meier (2003).

Additional details regarding operation of the Top-Down Bill Disaggregation Model 108 are provided below.

### Travel Footprint 130

To determine a user's travel footprint 130, questions are asked (or inputs 100 are requested) about the user's personal vehicles 166, flights 168, and other transportation 170 (e.g., vehicle rentals, taxis, and public transportation).

### Personal Vehicles 166

For personal vehicles 166, the user inputs 100 regarding the year/make/model of the vehicle are correlated with a database from the EPA's National Vehicle and Fuel Emissions Laboratory that provides the car's fuel efficiency in miles per gallon. Dividing the annual mileage of the car by the average fuel efficiency in miles per gallon yields gallons of gasoline consumed (gasoline 167). The system then divides the gallons of gasoline by the average number of passengers in the car to yield per person gallons of gasoline. The number of gallons used per year is converted to pounds of carbon dioxide using conversion factors from the Technical Guidelines Voluntary Reporting of Greenhouse Gases (DOE, 2006). For users who know their own vehicles actual miles per gallon, they can choose to overwrite the default fuel economy of their vehicle with an actual fuel economy input. This number (in miles per gallon) simply replaces the value assigned from the EPA year/make/model database.

### Flights 168

Users are given two options for inputting flight data: to provide specific information about the origin and destination of each flight they have taken in the past year, or to provide a general estimate of the number of flights they have taken and their length.

Users can also input their annual number of short flights (0 to 300 miles), medium flights (301 to 1000 miles), long flights (1001 to 3000 miles), and flights outside the US (extended flights, over 3000 miles). To convert the number of flights into carbon dioxide emissions, an average length in miles is assigned to each class of flights: short flights are 200 miles, medium flights 700 miles, long flights 2000 miles, and extended flights 5500 miles. In addition, for each flight class there is an emissions factor in pounds of carbon dioxide per flight mile derived from the World Resources Institute, GHG protocol initiative. Jet fuel use (jet fuel 169) is derived based on the carbon intensity of jet fuel. By multiplying the average flight length by the emissions factor, and summing for all the flights, the system derives the flight component 168 of the Travel footprint 130.

### Other Transportation 170

The other transportation component 170 of the travel footprint 140 includes vehicle rentals, public transport, taxis, and the like.

### Vehicle Rentals

Users can further refine the “driving” component of the Travel footprint 130 by describing the number of days the user rents a car each year, and specifying what type of car is typically rented (choices may be small car, midsize/sedan, minivan, SUV/pickup, hybrid SUV, and hybrid car). To calculate the associated consumption of gasoline, the number of rental car days is multiplied by an average daily driving load of 50 miles (number based on rental packages from various rental car companies). This yields annual rental car miles. The system then divides by the average fuel efficiency for a car in the class (derived by observational studies of EPA mileages of various cars in the class) to yield annual gallons of gasoline consumed for rented cars.

### Public Transport and Taxis

The user can also refine the Travel footprint 130 by answering questions or inputting information to define the “other” component. Specifically, the user can input how much the user spends on busses/taxis/commuter trains/subways, train travel between cities, and ferries/water taxis. For each of these three categories, there are corresponding multiplication factors that relate user-inputted dollars spent to both emissions of carbon dioxide based on data from Carnegie Mellon University Economic Input-Output Lifecycle Assessment (EIOLCA) program. By multiplying the dollars spent by the respective EIOLCA multiplication factor, and summing across the three spend categories, the system determines the “other” component of the Travel footprint.

### Work Footprint 132

The Work footprint 132 may be calculated in a number of different ways based on the user's occupation. Users get to choose from the following:
“I work at home.”
“I work in a building that manufactures stuff.”
“I work in a building that doesn't manufacture stuff.”
“I am a student or teacher.”
“I am unemployed.”

Based on the user's response, the user is directed down one of a number of paths, described below. The user is also asked to indicate the zip code in which he/she works, since some users may live in one zip code and commute to work in another.

### “I Work at Home” or “I am Unemployed”

For both of these responses, a user's work footprint is zero. An unemployed user does not work, so by definition must have a work footprint of zero. For a user that works at home, the fuel consumed in the course of this work will be included in the bills entered in the Home function questions, and will thus be part of the Home function. In cases where users do not enter bills, the default home energy use simulations are scaled to estimate extra energy use associated with working at home. However, it should be appreciated that the a user who works at home could input only information associated with a home office (that is not already included in the home footprint) to the extent possible, in order to obtain an indication regarding the portion of the overall footprint attributed to the home office.

“I Work in a Building that Doesn't Manufacture Stuff”

If a user indicates that she works in a non-manufacturing commercial field, the user is prompted to describe the type of building he/she works in with the following choices: school, supermarket or grocery store, restaurant, hospital, doctor or dentist office, hotel or motel, retail store, professional or administrative office, social space, police or fire department, place of religious worship, post office or copy center, dry cleaners/laundromat/beauty parlor, auto service or gas station, warehouse or storage facility. Each of these responses corresponds to one of the building types described in the EIA's Commercial Building Energy Consumption Survey (CBECS, 2003). This survey provides per worker electricity 158 and natural gas 160 consumption for each of these building types.

CBECS also assigns average per worker consumption of electricity and natural gas based on the census of the commercial building. A census is a geographical division, with nine censuses in the nation, each consisting of a varied number of states with a similar geography. For each census, a multiplication factor is derived that relates average consumption of electricity and natural gas to average consumption for the entire nation. As such, when a user reports his state, the system can assign him to a census and multiply the per worker consumption based on his building type by the census multiplication factor. This outputs a census- and building-modified per worker consumption of electricity 158 and natural gas 160. Since these are the only required inputs, these physical units of fuel can be converted to emissions of carbon dioxide and energy consumption using the same NERC subregion-level multiplication factors described earlier in the Home function.

Although these questions are enough to output an estimated Work footprint 132, the user will be able to refine his Work footprint 132 by providing information for any or all of the following:
The square footage of the building
The age of the building
The number of floors
The number of people working in the building
The hours of operation for the building
The building's exterior material

The CBECS survey provides per worker consumption of electricity 158 and natural gas 160 for workers in the different building characteristics outlined in each of these. For each response the system generates a multiplication factor that relates the building type with the overall average, and then multiplies it by the census- and building-modified per worker average. Since these are independent multiplication factors, the system can just sequentially multiply by them in any order. Moreover, if a user does not know the response to a question, or leaves it blank for any other reason, the system does not multiply by any factor and the per worker consumption does not change.

“I Work in a Building that Manufactures Stuff”

If a user indicates that they work in a building that manufactures things, the user is then prompted to describe the manufacturing subsector of the facility. The choices for this input are: food, beverage and tobacco products, textile mills, textile product mills, apparel, leather products, wood products, paper, printing-related support, petroleum and coal products, chemicals, plastics and rubber products, nonmetallic mineral products, primary metals, fabricated metal products, machinery, computer and electronic products, electrical equipment, transportation equipment, furniture and related products, miscellaneous. Each of these categories corresponds to a subsector in the EIA's Manufacturing Energy Consumption Survey (MECS, 2002). MECS gives the total consumption, consumption per employee, electricity consumption, and natural gas consumption, broken down by region (there are four regions in the nation, and each comprises at least two censuses). From this data, the system can derive per worker electricity 158 and natural gas 160 consumption for each region, and assign the user to one of the regions by knowing the user's work state. The system can then adjust the per worker numbers to account only for non-process consumption. In other words, the system does not assign to the user the electricity and natural gas that is used in the manufacturing process, but only the electricity and natural gas that is used for the benefit of the facility's workers, such as for HVAC, lighting, on-sight transportation, etc. Thus, with only the worker's state and subsector, the present invention can output per worker consumption of electricity 158 and natural gas 160 along with the overall Work footprint that is the sum of these two.

As with other footprint components, a user can return and refine the Work footprint 132 by answering more questions about the user's manufacturing job. For example, within certain subsectors, there are more specific industries. For instance, if a user selects the subsector “food”, the user may refine his industry to wet corn milling, sugar, fruits and vegetable canning, or I don't know/none of these. By selecting an industry, a user is assigned to a more specific category on the MECS survey, although the same data is available for the industry and it is manipulated in the same way. If a user selects “I don't know/none of these”, the system simply carries the calculation forward with the data from subsector rather than the more specific industry data. Not all subsectors have industries within them, so for those subsectors there is no corresponding question or input regarding the specific industry.

In addition, a user may also be asked to describe the number of workers in the user's manufacturing facility. From the MECS survey, the system can generate multiplication factors within each industry and subsector relating consumption for each facility size to the average consumption across all facilities. So, if a user is able to select the facility size, the system can multiply the consumption of electricity 158 and natural gas 160 by this multiplication factor to further refine the Work footprint 132. Once again, the system can convert to carbon dioxide emissions using the NERC subregion-level conversion factors used above.

### “I am a Student or Teacher”

If the user selects this statement, they are further asked to clarify whether they are a student or teacher, and in what level of schooling (kindergarten, elementary school, middle or high school, college or graduate school). Based on the response to this question, there a few pathways the system can take.

### “I am a Teacher in Kindergarten, Elementary School, or Middle/High School”

If a user is a teacher in kindergarten through high school, they are actually treated in the same way as those users who “work in a building that doesn't manufacture stuff.” In this pathway, outlined above, the user is normally prompted to describe the user's building. However, in the case of teachers, the system can assign the building type to “school.” Using this response, and the work state, the system can utilize CBECS data to yield per worker consumption of electricity 158 and natural gas 160.

In addition, as with the non-manufacturing questions outlined above, the user can refine the footprint by answering questions to describe the school's square footage, construction year, number of floors, number of employees, weekly operating hours, exterior wall material, and the like. The resulting CBEC S-derived multiplication factors can refine the user's Work footprint.

### “I am a Student in Kindergarten, Elementary School, or Middle/High School”

This pathway also utilizes the same CBECS pathway utilized above and in non-manufacturing buildings. However, that data outputs electricity and natural gas per employee, so the system adds another multiplication factor to the student pathway which accounts for the larger number of students as compared to just workers. This larger number will decrease the per student consumption of electricity and natural gas, as the total consumption is spread out over a wider range of students. Here a conscious decision is made to assign less consumption to students than teachers, as teachers are assigned per worker values, while students are assigned a value that is per (worker+student). This decision was made because students spend less time in the school than teachers do, and have a less direct financial stake and smaller choice to be in the school in the first place.

As above, the system can take the CBECS data for education buildings in the appropriate census division (based on user state). Now, the system multiplies by a factor relating number of worker to total number of workers and students. This factor is derived from the National Center for Education Statistics, which provides student to teacher ratios for kindergarten, elementary school and secondary school, as well as student to administrative staff ratio, all broken down by state. By combining these data, the system derives a ratio of workers to workers and students, which when multiplied by the per worker electricity and natural gas consumption, provided electricity 158 and natural gas 160 consumption per workers plus students. These outputs, electricity 158 and natural gas 160, are the subcategories for a student's footprint, and when summed, provides the overall Work footprint 132.

As with the non-manufacturing questions outlined above, the user can refine the footprint by answering questions to describe the school's square footage, construction year, number of floors, number of employees, weekly operating hours, exterior wall material, and the like. The resulting CBECS-derived multiplication factors can refine the user's Work footprint 132.

### “I am a Student or Teacher in College or Graduate School”

Students and teachers in college or grad school are treated as equals, in contrast to students and teachers at any other level of schooling. The reasoning that there is no difference between students and teachers in college relates to the fact that both spend comparable amounts of time in the school buildings, and both choose to be in the buildings for either current employment or training for potential future employment. In this category, published emissions inventories from dozens of colleges in the United States were researched, inventories that took into account all buildings on a university campus. These college reports were grouped into four regions, and the average carbon dioxide emissions per community member at the college was calculated. As such, a student or teacher in college or graduate school is assigned one of these average footprints, which are subsequently broken down into the subcategories of electricity, on-campus sources, and other.

### Shopping Footprint 134

The Shopping footprint 134 is meant to capture the indirect emissions associated with the manufacture and distribution of the products the end user purchases on a daily basis. To break down a typical user's spending into discrete categories, the system begins with 2005 consumer spend data from the U.S. Bureau of Labor Statistics (BLS) (or such data as may be updated from time to time), which details average spending by Americans in 13 broad categories:
Food and alcohol 178, which includes food at home, food away from home, and alcoholic beverages;
Housing 180, owned dwellings, rented dwellings, other lodging, utilities fuels and publics services (not included), household operations, household supplies, household furnishings and equipment;
Apparel and services;
Transportation, which includes vehicle purchases, gasoline and motor oil (not included), other vehicles expenses, and public transportation (not included);
Healthcare 182;
Entertainment;
Personal care products and services;
Reading;
Education;
Tobacco products and smoking supplies;
Miscellaneous (not included);
Cash contribution (not included); and
Personal insurance and pensions, which includes life and other personal insurance and pensions and social security.

For each of these categories, the description from the BLS survey was used to assign a reference category from Carnegie Mellon University's EIOLCA program. This process provides multiplication factors to convert the dollars spent in each of these categories to the corresponding emissions of carbon dioxide and energy consumption. Certain categories were omitted: utilities fuels and public services were omitted because these are included in the Home footprint 128, education was omitted because it is included in the student's Work footprint 132, gasoline/motor oil and public transportation were omitted because these are included in the Travel footprint 130, and miscellaneous and cash contributions were omitted because of difficulty in defining these for the user and in assigning an EIOLCA reference category. Thus, the four primary subcategories used to determine the hopping footprint comprise food and alcohol 178, hotels and housing 180, healthcare 182, and other 183 (which may comprise some or all of the remaining items from the 13 categories referenced above not included in the Home footprint 128, the Work footprint 132, or the Travel footprint 130).

In order to derive a Shopping footprint 134, the system multiplies the amount spent in each spend category (obtained via user input 100) by the corresponding EIOLCA multiplication factor and a value to adjust for inflation based on the BLS Consumer Price Index. To assign spending in each category without asking the user, the system utilizes data from the BLS survey, which provides average consumer spending for each of these categories, broken down by income range of the consumer. This is based on the user's household's combined annual income or, when not provided, the U.S. average household income for 2005. Based on the user's reported income, the system can assign the average spending for the user's family in each of the spend categories.

For example in determining the footprint for the food and alcohol subcategory 178, the user is also asked to input whether he/she is a vegetarian, vegan, or omnivore. BLS survey data is used to estimate food expenditure in each major food category (cereals and breads, chicken and fish, red meat, dairy products, fruits and vegetables, and sugars and sweets) based on income level. The estimated calories consumed are derived for each food type based on the average calories per dollar for that food type. For users who are vegan, the system replaces all red meat, chicken/fish, and dairy calories with an equal division of grains and breads and fruits and vegetable calories. For vegetarian users, the system divides red meat and chicken/fish calories equally between fruits and vegetables, grains and breads, and dairy.

If a user chooses to refine the Shopping footprint 134, the user may input the specific amount of spending in each of the subcategories 178, 180, 182, and 183. There is also an additional subcategory, credit card spending, which may be incorporated into the other subcategory 183 since purchasing any product with a credit card as opposed to cash leads to additional emissions of carbon dioxide and energy consumption. To allow maximal flexibility for users, they can enter weekly, monthly, or yearly spending for each of the spend categories, and the system can annualize these numbers.

Energy End-Use Determination with Bottom Up Energy Mapping Model 110

As discussed above, Bottom Up Energy Mapping Model 110 specifies regression models for each energy end-use. This regression analysis consists of four major residential energy end-use categories: space heating 124, water heating 126, cooling 120, and appliance 122, but can of course be expanded to include other categories as would be apparent to those skilled in the art. In accordance with the present invention, a statistical regression model is created for each category with the micro-data files from The Residential Energy Consumption Survey (RECS) in 2005 (or as updated from time to time). This survey collected data from 4382 households randomly sampled through a multistage, area-probability design method to represent 111.1 million U.S. households, the Census Bureau's statistical estimate for all occupied housing units in 2005. Each sampling weight value was used as weighting factor for the analysis.

Ordinary Least Square (OLS) method was used with predictor variables such as energy price, household characteristics, housing unit characteristics, geographical characteristics, appliance ownership and use pattern, and heating/cooling degree-days. Dependent variables of the four regressions were natural log values of per household energy use for heating, water heating, appliance, and cooling. The model can be formulated as

$$ln {E}_{j} = {β}_{j 0} + {\sum }_{i} {β}_{ij} \cdot {X}_{i , RECS} + {ɛ}_{j} , \qquad ( 1 )$$

where j indicates the four categories of heating 124, water heating 126, cooling 120, or appliance 122, Eⱼ is total annual energy consumption for each end use, and X_{i,RECS} means variable Xᵢ (e.g. housing type) whose value is from the RECS dataset. This RECS notation is used because later the system also uses Xᵢ values from other datasets for prediction purpose. The dependent variables Eⱼ are aggregation of energy use per fuel per end-use which the Energy Information Administration (EIA) estimated from the total fuel uses per household. Each means

$$\{ \begin{matrix}{E}_{water} = {E}_{water , NG} + {E}_{water , EL} + {E}_{water , F O} + {E}_{water , LP} \\ {E}_{heating} = {E}_{heating , NG} + {E}_{heating , EL} + {E}_{heating , F O} + {E}_{heating , LP} \\ {E}_{appliance} = {E}_{appliance , NG} + {E}_{appliance , EL} \\ {E}_{cooling} = {E}_{cooling , EL} ,\end{matrix} \qquad ( 2 )$$

where NG means natural gas, EL electricity, FO fuel oil, and LP propane. The regressions results for selected major variables are shown in Table 2 below. These regression models will be used to predict household energy use with more granular data source.

### Leveraging Census Data to Achieve High Geographical Resolution

Since a goal of the present invention is to estimate per-household energy use in a geographical resolution in as granular a manner as possible, the resolution in the RECS dataset, which is the U.S. division-level, was not satisfactory. Instead, the system makes use of the U.S. Census 2000 dataset which contains 5-digit zip code level information for many independent variables used in the regressions, such as household characteristics. In terms of weather data, the closest weather station from the center of each zip code area is selected, out of hundreds of weather stations scattered nationwide, and the 5 year average values of the climate variables from that station are used.

Then, the independent variables in the four main regressions can be divided into two groups A and B: A with variables Xₐᵢ whose values exist in both RECS and Census datasets, and B with variables X_{bi} that exist only in RECS dataset. For example, the group A will include information about years when the structure was built, heating fuel types, housing types, number of rooms, or household income, while the group B contains number of windows, housing wall types, or appliance ownership and use patterns. Because all these variables are used in the main regression models, the system needs to have proxies for the variables in the second group in order to predict zip code level per-household energy use.

For this purpose, separate sub-regressions were run with the variables in the group A to estimate the variables in the group B. That is,

$${X}_{bk , RECS} = {γ}_{k 0} + {\sum }_{i} {γ}_{ik} \cdot {X}_{ai , RECS} + {δ}_{k} , \qquad ( 3 )$$

Then, the Census and the weather data X_{a,census} can be plugged into these sub-regression models to predict \hat{X}_{bi}s for each zip code area.

$$\hat{{X}_{bk}} = \hat{{γ}_{k 0}} + {\sum }_{i} \hat{{γ}_{ik}} \cdot {X}_{ai , census} , \qquad ( 4 )$$

These \hat{X}_{bi}s which will in turn be used to predict zip code level energy estimates Êⱼ

$$\hat{ln {E}_{j} =} \hat{{β}_{j 0}} + {\sum }_{i ∈ A} {\hat{β}}_{ij} \cdot {X}_{i , census} + {\sum }_{i ∈ B} {\hat{β}}_{ij} \cdot \hat{{X}_{bi}} , \qquad ( 5 )$$

In the equation (4), for dichotomous variables like ownership variables, logistic regressions are used to obtain probabilities of owning each appliance. These probability outputs enable the system to model a probabilistic household in each zip code. For example, a representative household may have 0.6 units of electric water heater and 0.4 units of natural gas one.
Rearranging the estimated end-use energy consumption to obtain energy use per fuel

As a way of validating this approach, the estimated nationwide consumption of each fuel is compared with the actual statistics released from the EIA every year. To estimate nationwide fuel consumption, the results from above which were per-household energy use are rearranged for different end use categories.

First, it is assumed that all cooling energy is from electricity. So all Ê_{cooling} is added to electricity use. Second, water heating and space heating energy, Ê_{water} and Ê_{heating}, are divided into four different fuel types depending on the coefficients of the regressions and the percentage of households using each fuel in the zip code area. Since the model is log-linear, each coefficient β of a dichotomous variable can mean, when β is small, 100·β% change in the dependent variable (since e^{β}≈1+β). For example, according to Table 2 below, “Fuel oil furnace” has the coefficient 0.280, which means households using fuel oil heating equipment use about 32.3% more heating energy than others with everything else equal. From this consideration, the system can disaggregate each end-use energy for a representative household to obtain energy use per each fuel type by the following equation. For a particular zip code area j, heating energy from gas for the representative household is:

$${E}_{j , heating , gas} = {E}_{j , heating} \cdot \frac{{r}_{j , gas} \cdot {e}^{{β}_{gas}}}{{\sum }_{all fuel i} {r}_{j , i} \cdot {e}^{{β}_{i}}} , \qquad ( 6 )$$

which can be multiplied by total number of households to estimate total heating energy from gas in the area. Here r_{j,i} means the proportion of households using fuel i as the main heating fuel in an area with zip code j. The same approach is applicable to all other fuel types used for water and space heating.

Third, since appliance energy is used for various purposes, the system cannot divide it as simply as the method above. Lighting or refrigerator is entirely driven by electricity, while energy use for stove, oven, pool, spa, dryer, and grill may come from either gas or electricity. Since a majority of households (according to the RECS data, it is about 54%.) use only electricity for all appliance use, the system cannot treat all the households in the same way when modeling other fuel usage for appliances. Instead, first a regression model is built only with households using not only electricity for appliances to estimate the ratio \hat{r}ₑ of electricity to total appliance energy. Second, the probability pⱼ of using 100% electricity for each representative household is estimated. For this, a logistic regression can be run with a dependent variable of whether each household uses 100% electricity for appliances or not. With this probability an expected ratio E[rₑ] of electricity use can be calculated for appliances in the region.

E[rₑ]=pⱼ·1+(1−pⱼ)·\hat{r}ₑ, (7)

### Specific Regression Outputs

From the log value that is obtained from the regression models, actual estimated energy can be obtain by:

\hat{Eⱼ}=exp(RMSE²/2)exp(1{circumflex over (n Eⱼ))}

The scaling value exp(RMSE²/2) is needed when using a log-linear model because without it the expected value of Eⱼ is systematically underestimated (Wooldridge 2006: p 219). RMSE means root mean square error of each model.

The full lists of significant variables and coefficients for each regression with the descriptions about the variables are set forth below. Regressions are run by STATA 10.0 software.

Water heating 126
Linear regression
Number of obs = 4326
F(15, 4310) = 400.21
Prob > F = 0.0000
R-squared = 0.6251
Root MSE = .46895

| | | Robust | | | | |
|---|---|---|---|---|---|---|
| ln_btu_water | Coef. | Std. Err. | t | P > \|t\| | [95% Conf. Interval] | |
| hhage | −.0019148 | .0005643 | −3.39 | 0.001 | −.003021 | −.0008085 |
| totroomssq | .0030588 | .0003986 | 7.67 | 0.000 | .0022773 | .0038403 |
| p_el_water | −15.83872 | 1.704797 | −9.29 | 0.000 | −19.181 | −12.49644 |
| origin1_2 | .1118637 | .0270679 | 4.13 | 0.000 | .0587967 | .1649308 |
| hhincome | 1.10e−06 | 2.67e−07 | 4.11 | 0.000 | 5.74e−07 | 1.62e−06 |
| nhsldmem | .2751995 | .0206191 | 13.35 | 0.000 | .2347754 | .3156235 |
| hhsize_sq | −.0192682 | .0028 | −6.88 | 0.000 | −.0247576 | −.0137789 |
| fuelh2o_1 | −.368475 | .0383099 | −9.62 | 0.000 | −.4435821 | −.2933679 |
| fuelh2o_2 | −.2511165 | .0590227 | −4.25 | 0.000 | −.3668313 | −.1354016 |
| fuelh2o_5 | −.7797437 | .0607233 | −12.84 | 0.000 | −.8987927 | −.6606948 |
| water_ht_s~4 | .0972051 | .0198582 | 4.89 | 0.000 | .0582728 | .1361374 |
| dishwash | .0598905 | .0175248 | 3.42 | 0.001 | .0255329 | .0942481 |
| washtemp1 | .4439988 | .0402474 | 11.03 | 0.000 | .3650932 | .5229045 |
| washtemp2 | .4229196 | .030576 | 13.83 | 0.000 | .3629749 | .4828644 |
| washtemp3 | .3614403 | .0310277 | 11.65 | 0.000 | .30061 | .4222705 |
| _cons | 9.261808 | .063433 | 146.01 | 0.000 | 9.137446 | 9.386169 |

Definitions of acronyms:
hhage: Age of householder
totroomssq: Total number of rooms
p_el_water: Electricity price for households using electric water heater
origin1_2: Householder's race is black (0 for NO, 1 for YES)
hd65: Number of heating degree days (base 65)
hd65sq: Squared value of hd65
hhincome: Total combined household income in the past 12 months
nhsldmem: Number of people in the household
hhsize_sq: Squared value of nhsdmem
fuelh2o_1: Water heater fuel is natural gas (0 for NO, 1 for YES)
fuelh2o_2: Water heater fuel is LPG or propane (0 for NO, 1 for YES)
fuelh2o_5: Water heater fuel is electricity (0 for NO, 1 for YES)
water_ht_size4: Water heater size is larger than 50 gallons (0 for NO, 1 for YES)
dishwash: I have a dishwasher (0 for NOT HAVE, 1 for HAVE)
washtemp1: Temperature setting is hot for wash cycle of the clothes washer (0 for NO, 1 for YES)
washtemp2: Temperature setting is warm for wash cycle of the clothes washer (0 for NO, 1 for YES)
washtemp3: Temperature setting is cold for wash cycle of the clothes washer (0 for NO, 1 for YES)

Space heating 124
Linear regression
Number of obs = 3255
F(26, 3227) = .
Prob > F = .
R-squared = 0.8228
Root MSE = .51131

| | | Robust | | | | |
|---|---|---|---|---|---|---|
| ln_btu_hea~g | Coef. | Std. Err. | t | P > \|t\| | [95% Conf. Interval] | |
| hhage | .0023519 | .0006557 | 3.59 | 0.000 | .0010664 | .0036375 |
| year_built1 | .2769704 | .0365273 | 7.58 | 0.000 | .2053513 | .3485895 |
| year_built2 | .1438618 | .0433352 | 3.32 | 0.001 | .0588944 | .2288291 |
| year_built3 | .1538804 | .0315587 | 4.88 | 0.000 | .0920033 | .2157575 |
| year_built4 | .1169923 | .0370922 | 3.15 | 0.002 | .0442657 | .189719 |
| year_built5 | .0907707 | .0278293 | 3.26 | 0.001 | .0362058 | .1453356 |
| totsqft | .0000414 | 7.34e−06 | 5.64 | 0.000 | .000027 | .0000558 |
| hd65 | .0006196 | .0000199 | 31.06 | 0.000 | .0005805 | .0006587 |
| hd65sq | −4.20e−08 | 2.22e−09 | −18.91 | 0.000 | −4.63e−08 | −3.76e−08 |
| hhincome | 1.23e−06 | 3.38e−07 | 3.63 | 0.000 | 5.66e−07 | 1.89e−06 |
| hometype5 | −.2652087 | .0413395 | −6.42 | 0.000 | −.346263 | −.1841544 |
| tempgone | .0093975 | .0024896 | 3.77 | 0.000 | .0045161 | .014279 |
| temphome | .0070905 | .0034718 | 2.04 | 0.041 | .0002833 | .0138978 |
| division3 | −.0667746 | .0324789 | −2.06 | 0.040 | −.1304559 | −.0030932 |
| division4 | −.1458849 | .0375755 | −3.88 | 0.000 | −.2195592 | −.0722106 |
| equip_agesq | .0003276 | .0000671 | 4.88 | 0.000 | .000196 | .0004592 |
| fuelheat3 | .2801609 | .0376384 | 7.44 | 0.000 | .2063633 | .3539585 |
| fuelheat5 | −1.101107 | .0499627 | −22.04 | 0.000 | −1.199069 | −1.003145 |
| fuelheat6 | −1.83068 | .1745534 | −10.49 | 0.000 | −2.172927 | −1.488433 |
| fuelheat7 | −3.355688 | .0490265 | −68.45 | 0.000 | −3.451815 | −3.259562 |
| fuelheat9 | −1.45489 | .7220891 | −2.01 | 0.044 | −2.87069 | −.0390908 |
| walltype1 | .0832143 | .0232004 | 3.59 | 0.000 | .0377252 | .1287033 |
| walltype2 | .0612561 | .0279206 | 2.19 | 0.028 | .0065121 | .116 |
| urbrural1 | −.0451486 | .0203044 | −2.22 | 0.026 | −.0849594 | −.0053377 |
| origin1_2 | .186817 | .0358088 | 5.22 | 0.000 | .1166067 | .2570272 |
| p_el_heat_sq | −211.462 | 62.55535 | −3.38 | 0.001 | −334.1142 | −88.80976 |
| numwindow | .0114514 | .0018624 | 6.15 | 0.000 | .0077999 | .0151029 |
| _cons | 7.094483 | .1978898 | 35.85 | 0.000 | 6.706481 | 7.482486 |

Definitions of acronyms:
hhage: See above
year_built1: The house was built before 1940? (0 for NO, 1 for YES)
year_built2: The house was built in 1940's? (0 for NO, 1 for YES)
year_built3: The house was built in 1950's? (0 for NO, 1 for YES)
year_built4: The house was built in 1960's? (0 for NO, 1 for YES)
year_built5: The house was built in 1970's? (0 for NO, 1 for YES)
totsqft: Total square footage of the house
hd65: See above
hd65sq: See above
hhincome: See above
hometype5: Apartment with 5 or more units (0 for NO, 1 for YES)
temphome: Thermostat setting during the day when someone is home
tempgone: Thermostat setting during the day when no one is home
division3: East North Central census division? (0 for NO, 1 for YES)
division4: West North Central census division? (0 for NO, 1 for YES)
equip_agesq: Squared value of age of the main heating equipment
fuelheat3: The fuel for space heating is fuel oil (0 for NO, 1 for YES)
fuelheat5: The fuel for space heating is electricity (0 for NO, 1 for YES)
fuelheat6: The fuel for space heating is wood (0 for NO, 1 for YES)
fuelheat7: The fuel for space heating is solar (0 for NO, 1 for YES)
fuelheat9: Other fuels for space heating (0 for NO, 1 for YES)
walltype1: The wall is made of brick (0 for NO, 1 for YES)
walltype2: The wall is made of wood (0 for NO, 1 for YES)
urbrural1: The house is in a city (0 for NO, 1 for YES)
origin1_2: See above
p_el_heat_sq: Squared value of electricity price for households using electric heating equipment
numwindow: Number of windows

Cooling 120
Linear regression
Number of obs = 3494
F(16, 3477) = 535.11
Prob > F = 0.0000
R-squared = 0.7500
Root MSE = .52763

| | | Robust | | | | |
|---|---|---|---|---|---|---|
| ln_btu_cool | Coef. | Std. Err. | t | P > \|t\| | [95% Conf. Interval] | |
| hhage | −.002784 | .000678 | −4.11 | 0.000 | −.0041133 | −.0014548 |
| numchild | .2063615 | .0247512 | 8.34 | 0.000 | .1578331 | .2548899 |
| numadul | .2465963 | .023528 | 10.48 | 0.000 | .2004663 | .2927263 |
| p_el | −9.169043 | 1.878077 | −4.88 | 0.000 | −12.85129 | −5.486799 |
| p_el_sq | −52.29975 | 11.23761 | −4.65 | 0.000 | −74.33273 | −30.26678 |
| totsqft | .0000293 | 6.27e−06 | 4.68 | 0.000 | .000017 | .0000416 |
| cd65 | .0016041 | .0000517 | 31.00 | 0.000 | .0015027 | .0017056 |
| cd65sq | −2.15e−07 | 1.07e−08 | −20.02 | 0.000 | −2.36e−07 | −1.94e−07 |
| hhincome | 1.03e−06 | 3.38e−07 | 3.05 | 0.002 | 3.67e−07 | 1.69e−06 |
| hhsize_sq | −.018882 | .0031075 | −6.08 | 0.000 | −.0249748 | −.0127893 |
| division9 | −.3372462 | .0391932 | −8.60 | 0.000 | −.4140902 | −.2604022 |
| cool_type3 | .3183809 | .0727231 | 4.38 | 0.000 | .1757966 | .4609653 |
| acrooms | .1114088 | .0037959 | 29.35 | 0.000 | .1039663 | .1188512 |
| cenachp_1 | .0495026 | .0244144 | 2.03 | 0.043 | .0016347 | .0973706 |
| urbrural1 | −.0756085 | .0207515 | −3.64 | 0.000 | −.1162949 | −.0349222 |
| origin1_41 | −.1831339 | .0683612 | −2.68 | 0.007 | −.3171661 | −.0491017 |
| _cons | 6.309177 | .0975152 | 64.70 | 0.000 | 6.117984 | 6.50037 |

Definitions of acronyms:
hhage: See above
numchild: Number of children under 18
numadul: Number of adults
p_el: Price of electricity
p_el_sq: Squared value of electricity price
totsqft: See above
cd65: Number of cooling degree days (base 65)
cd65sq: Squared value of cd65
hhincome: See above
hhsize_sq: See above
division9: Pacific census division? (0 for NO, 1 for YES)
cool_type3: The household has both central and individual AC units (0 for NO, 1 for YES)
acrooms: Number of rooms cooled by AC
cenachp_1: The central AC system is a heat pump (0 for NO, 1 for YES)
urbrural1: See above
origin1_41: Householder's race is Asian (0 for NO, 1 for YES)

Appliance 122
Linear regression
Number of obs = 4078
F(28, 4049) = 202.08
Prob > F = 0.0000
R-squared = 0.6477
Root MSE = .37412

| | | Robust | | | | |
|---|---|---|---|---|---|---|
| ln_btu_appl | Coef. | Std. Err. | t | P > \|t\| | [95% Conf. Interval] | |
| p_el | −11.18999 | 1.235028 | −9.06 | 0.000 | −13.61132 | −8.768653 |
| p_el_sq | 16.64141 | 8.075274 | 2.06 | 0.039 | .8094293 | 32.47339 |
| totsqft | .0000857 | .000014 | 6.14 | 0.000 | .0000583 | .0001131 |
| totsqftsq | −6.09e−09 | 1.69e−09 | −3.60 | 0.000 | −9.41e−09 | −2.78e−09 |
| hometype5 | −.1640161 | .0259402 | −6.32 | 0.000 | −.2148733 | −.113159 |
| nhsldmem | .1792048 | .0160376 | 11.17 | 0.000 | .1477623 | .2106473 |
| hhsize_sq | −.0118742 | .0021931 | −5.41 | 0.000 | −.0161738 | −.0075746 |
| division6 | .0558386 | .0277008 | 2.02 | 0.044 | .0015299 | .1101474 |
| stove_fuel3 | −.272899 | .0135172 | −20.19 | 0.000 | −.2994001 | −.2463979 |
| lgt12 | .0377191 | .0061534 | 6.13 | 0.000 | .025655 | .0497831 |
| lgt4 | .0141112 | .0039536 | 3.57 | 0.000 | .0063599 | .0218624 |
| lgt1 | .008134 | .0034823 | 2.34 | 0.020 | .0013067 | .0149612 |
| no_outlgtnt | −.0760747 | .0151114 | −5.03 | 0.000 | −.1057012 | −.0464481 |
| sepfreez | .138147 | .0137355 | 10.06 | 0.000 | .1112178 | .1650762 |
| dishwash | .0773837 | .0155 | 4.99 | 0.000 | .0469952 | .1077721 |
| dryer | .2857843 | .0225338 | 12.68 | 0.000 | .2416056 | .329963 |
| waterbed | .1222974 | .0386256 | 3.17 | 0.002 | .0465699 | .1980248 |
| tvcolor | .0564086 | .0056364 | 10.01 | 0.000 | .0453582 | .067459 |
| aquarium | .1548385 | .0279789 | 5.53 | 0.000 | .0999845 | .2096925 |
| cellphon | .0505383 | .0171615 | 2.94 | 0.003 | .0168922 | .0841843 |
| computer | .0744663 | .0166173 | 4.48 | 0.000 | .0418873 | .1070453 |
| fax | .075352 | .0208854 | 3.61 | 0.000 | .0344053 | .1162988 |
| urbrural1 | −.0708163 | .0137697 | −5.14 | 0.000 | −.0978124 | −.0438202 |
| numfrig | .1692989 | .0138516 | 12.22 | 0.000 | .1421421 | .1964557 |
| rfg_age_test | .0163494 | .0043183 | 3.79 | 0.000 | .0078832 | .0248156 |
| rfg_age_te~q | −.0006252 | .0002281 | −2.74 | 0.006 | −.0010723 | −.000178 |
| poolheat2 | .6981702 | .0487713 | 14.32 | 0.000 | .6025515 | .7937888 |
| origin1_2 | .072521 | .0204553 | 3.55 | 0.000 | .0324173 | .1126247 |
| _cons | 9.277148 | .0546779 | 169.67 | 0.000 | 9.169949 | 9.384346 |

Definitions of acronyms:
totsqft: See above
hometype1: Mobile home? (0 for NO, 1 for YES)
hometype5: See above
nhsldmem: See above
hhsize_sq: See above
division1: New England census division? (0 for NO, 1 for YES)
division6: See above
stove_fuel3: Stove fuel is electricity (0 for NO, 1 for YES)
lgt12: Number of indoor lights that are on more than 12 hours a day
lgt4: Number of indoor lights that are on 4 to 12 hours a day
lgt1: Number of indoor lights that are on 1 to 4 hours a day
no_outlgtnt: I don't have outdoor lights on for all night (0 for HAVE, 1 for HAVE NOT)
sepfreez: Separate freezer (0 for HAVE NOT, 1 for HAVE)
dishwash: Dishwasher (0 for HAVE NOT, 1 for HAVE)
dryer: Clothes dryer (0 for HAVE NOT, 1 for HAVE)
waterbed: Heated water bed (0 for HAVE NOT, 1 for HAVE)
tvcolor: Number of color TV sets
aquarium: Aquarium (0 for HAVE NOT, 1 for HAVE)
cellphon: Cell phone (0 for HAVE NOT, 1 for HAVE)
computer: Personal computer (0 for HAVE NOT, 1 for HAVE)
fax: Fax (0 for HAVE NOT, 1 for HAVE)
urbrural1: See above
numfrig: Number of refrigerator (3 for 3 or more fridges)
rfg_age_test: Age of the main refrigerator
poolheat2: Heated pool (0 for HAVE NOT, 1 for HAVE)
origin1_2: See above

### Detailed Methodology for Top-Down Bill Disaggregation Model 108

In order to decompose a total energy bill (e.g., electricity bill 104 or natural gas bill 106) to acquire energy use for each end use, a linear model is needed, which has the additive relationship between independent variables and the final variable, which is total energy consumption. In this method, total consumption of a certain type of fuel for any single household will be expressed linearly as

E_{fuel}=Eₐₚₚₗ+E_{heating}+E_{water}+E_{cooling}, (1)

Each sub-component of total fuel use will be the estimates for each end use consumption. However, the system cannot run a simple linear regression because the error term in the model does not satisfy the homoskedasticity condition of least square method, which means that the variances of error terms are not a constant across all household samples. To account for this problem, the EIA notes that from its previous analysis it discovered that with a non-linear model

E_{fuel,i}^{1/4}={E_{appl,i}+E_{heating,i}+E_{water,i}+E_{cooling,i}}^{1/4}+ε, (2)

where i means i-th household, the error term ε is more normally distributed and has approximately a constant variance (Latta, 1983). This nonlinear least square method is adopted, which will minimize ε² in the model. Each term on the right side can be separated from the others by using indicator variables specifying each term such as fueltype5 or aircond. Each respectively denotes whether users have electricity as a main fuel and whether users have air-conditioning or not. This non-linear regression will provide four sub-equations for the four terms on the right side. Before using the results from the four sub-equations, provided that the system already has the total energy consumption values, it can normalize each term by the sum of all terms in the equation (1) to avoid over or underestimation of the total values. It can be shown as

$${\hat{E}}_{j , i} = {\tilde{E}}_{j , i} \cdot \frac{{E}_{fuel , i}}{( {\tilde{E}}_{appl , i} + {\tilde{E}}_{heating , i} + {\tilde{E}}_{water , i} + {\tilde{E}}_{cooling , i} )} , , \qquad ( 3 )$$

where E_{fuel,i} is the total annual bill for household i and fuel type fuel, \tilde{E}_{j,i} means energy use estimation from the sub-equations and \tilde{E}_{j,i} means the final scaled estimation for the end use j.

For example, from this method, the sub-equations acquired for electricity bill 104 decomposition are

$$1 ) Electricity use for water heating {\tilde{E}}_{water , i} = 2812.89 * w\_nhsldmem + 2275.053 * w\_washtemp 2 + 76.46017 * w\_totroomssq \\ 2 ) Electricity use for cooling {\tilde{E}}_{cooling , i} = .0006193 * c\_cd65sq + 119.0196 * c\_acroomssq + 6536.017 * c\_division6 - 2397.373 * c\_division9 - 1958.258 * c\_hometype5 + .1688467 * c\_cd65 \_income + 4919.83 * c\_cool \_type3 + 553.6155 * c\_nhsldmem \\ 3 ) Electricity use for heating {\tilde{E}}_{heating , i} = - 2774.187 * h\_hometype5 + 4.291386 * h\_hd65 - .0003958 * h\_hd65sq + 2784.983 * fuelheat\_aux5 + 1.718781 * h\_totsqft - 2490.544 * h\_urbrurall \\ 4 ) Electricity use for appliance {\tilde{E}}_{water , i} = 4655.506 * sepfreez + 1607.651 * tvcolor + 4817.51 * numfrig + 16601.71 * poolheat 2 + 2096.751 * dishwash + 1523.624 * lgt 12 + 522.3203 * lgt 1 + 1444.39 * computer - 3194.872 * no\_outlgtnt + .0001471 * totsqftsq + 3071.921 * dryrfuel 5 + 2907.104 * nhsldmem - 193.4315 * hhsize\_sq + 5713.307 * aquarium - 1175.929 * urbrurall + 89.69303 * rfg\_age \_test + 3653.508 * waterbed - 124.9693 * moneypy + 2886.367 * division 7$$

### Reference

Latta, R. B. (1983). Regression analysis of energy consumption by end use. Washington, D.C., Energy Information Administration.

II. Personal Energy Advisor

The Personal Energy Advisor is an energy use, physical resource and greenhouse gas emissions calculator that provides high-resolution, user-adaptable and personalized estimates of the amount of energy, greenhouse gas (including carbon dioxide), dollars, water, electricity, oil, gasoline, jet fuel, natural gas, coal and other resources consumers or organizations emit and/or save by engaging in specific behaviors, taking specific actions, or making specific purchases.

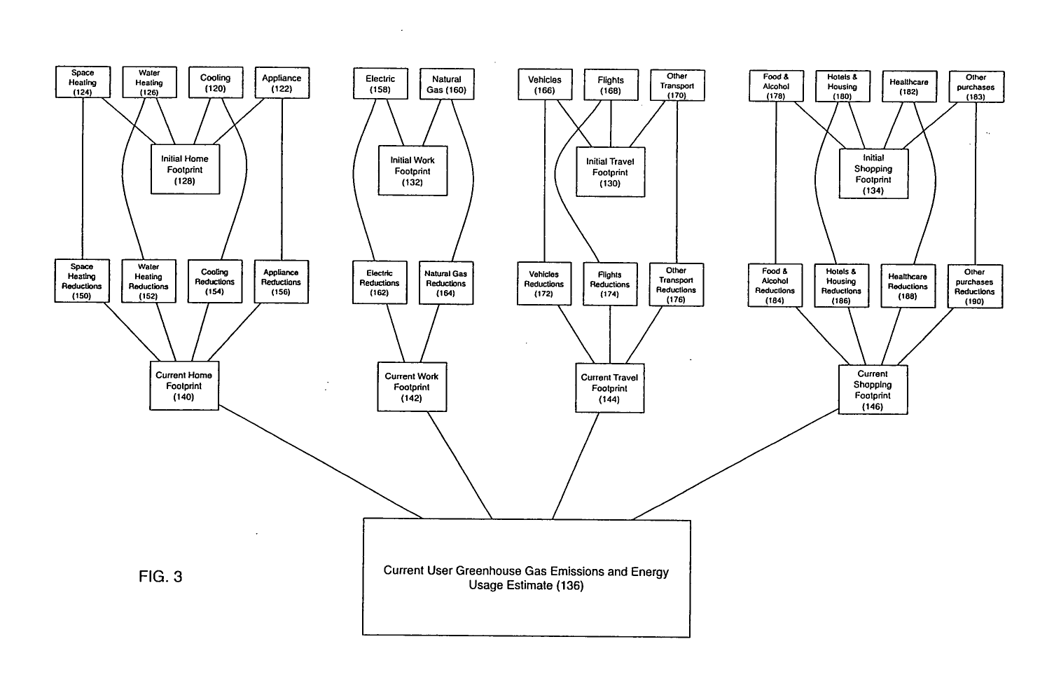

FIG. 3 shows a flowchart of an example embodiment of the Personal Energy Advisor Software. The processes described in the FIG. 2 flowchart may be implemented on the system shown in FIG. 1.

The starting point for the Personal Energy Advisor is the initial footprint categories determined in connection with the Energy Mapping Software described above. Accordingly, in FIG. 3, the Initial Home Footprint 128, the Initial Travel Footprint 130, the Initial Work Footprint 132, and the Initial Shopping Footprint 134 correspond to the Home Footprint 128, the Travel Footprint 130, the Work Footprint 132, and the Shopping Footprint 134 of FIG. 2. Further, at least initially, the initial greenhouse gas emissions and energy use estimate 136 of FIG. 2 will correspond to the current user footprint 136 of FIG. 3. Sub-category reductions may be based on user-selected actions or purchases in connection with the initial Home, Travel, Work and Shopping Footprint values to provide a Current Home Footprint 140, a Current Work Footprint 142, a Current Travel Footprint 144, and a Current Shopping Footprint 146. The Current User Footprint 136 may then be updated by subtracting the sub-category reductions from the initial (or previously determined) Current User Footprint 136 in order to determine the impact of a selected or proposed user action or purchase on the overall greenhouse gas emissions and energy usage of the end-user. Such actions or purchases may be input via user interface 12 of FIG. 1.

For example, in connection with the Initial Home Footprint 128, user inputs may be received regarding an action or purchase (or proposed action or purchase) in connection with the user's space heating, water heating, cooling, and appliance information. The system will then determine an appropriate reduction for the action or purchase (e.g., one or more of space heating reductions 150, water heating reductions 152, cooling reductions 154, appliance reductions 156), which can then be subtracted from the initial values determined by the Energy Mapping Software for space heating 124, water heating 126, cooling 120, and appliance 122 (or those values as previously modified by the Personal Energy Advisor Software in connection with previously entered actions and/or purchases) to provide the Current Home Footprint 140.

In connection with the Initial Work Footprint 132, user inputs may be received regarding an action or purchase (or proposed action or purchase) in connection with the user's electric 158 or natural gas usage 160. The system will then determine an appropriate reduction for the action or purchase (e.g., one or more of electric reductions 162, natural gas reductions 164, or the like), which can then be subtracted from the initial values determined by the Energy Mapping Software for electric 158 and natural gas 160 (or those values as previously modified by the Personal Energy Advisor Software in connection with previously entered actions and/or purchases) to provide the Current Work Footprint 142.

For the Initial Travel Footprint 130, user inputs may be received regarding an action or purchase (or proposed action or purchase) in connection with the user's vehicle, flight, or other transportation information. The system will then determine an appropriate reduction for the action or purchase (e.g., one or more of vehicle reductions 172, flight reductions 174, and other transportation reductions 176), which can then be subtracted from the initial values determined by the Energy Mapping Software for vehicles 166, flights 168, and other transportation 170 (or those values as previously modified by the Personal Energy Advisor Software in connection with previously entered actions and/or purchases) to provide the Current Travel Footprint 144.

In connection with the Initial Shopping Footprint 134, user inputs may be received regarding an action or purchase (or proposed action or purchase) in connection with the user's food and alcohol, hotels and housing, healthcare, or other purchasing information. The system will then determine an appropriate reduction for the action or purchase (e.g., one or more of food and alcohol reductions 184, hotels and housing reductions 186, healthcare reductions 188, and other purchases reductions 190), which can then be subtracted from the initial values determined by the Energy Mapping Software for food and alcohol 178, hotels and housing 180, healthcare 182, and other purchases 183 (or those values as previously modified by the Personal Energy Advisor Software in connection with previously entered actions and/or purchases) to provide the Current Shopping Footprint 146.

The Current Home Footprint 140, Current Work Footprint 142, Current Travel Footprint 144, and Current Shopping Footprint 146 can then be summed to provide the Current User Footprint 136. It should be appreciated that where no reduction input information is received for a particular category or sub-category, the footprint attributable from that category or sub-category will remain as initially determined in connection with the Energy Mapping Software discussed above or as previously modified by the Personal Energy Advisor Software.

Unlike other calculators, such as Yahoo! Green or An Inconvenient Truth Calculator, which are limited to providing outputs that apply across individuals in a zip code, state or even nation, the Personal Energy Advisor can yield reliable, market-leading estimates that apply specifically to the end user and no one else. The Personal Energy Advisor provides the foundation for an innovative kind of personalized e-commerce and conservation experience capable of dramatically spurring the transition to a sustainable future. The system makes it possible for energy efficiency and e-commerce to take into account an individual or organization's demographic, psychographic and energy usage characteristics, lifestyle or business habits, and purchasing decisions to determine the behavior, action or product that maximizes the user's end goal, including maximizing carbon dioxide emissions reductions, maximizing dollar savings, maximizing the savings of particular resources, maximizing the cost per carbon dioxide reduced ratio, and others.

Personal Energy Advisor is both a tool to assist consumers and organizations in making decisions about actions and purchases in their everyday lives, as well as a method for collecting data regarding such decisions. Certain representative features of the Personal Energy Advisor are listed below. This list is not intended to be exhaustive:

Algorithms may output: (1) energy savings as a rate or absolute value; (2) CO2 emissions and other greenhouse gas reductions as a rate or absolute value; (3) investment cost/annual dollar savings as a rate of absolute value; and (4) resource savings associated with any of the other following outputs relevant to the behavior, action or purchase—including water, gasoline, electricity, paper, natural gas, heating oil, and others—as a rate or absolute value;

Algorithms rely upon on user-specific equations and variables—that is, they may be geared towards the individual choices (inputs stemming from actions taken or products purchased) of the user and differentiate between such choices to yield distinct outputs for the particular user. This includes the ability of the user to replace default values used in the calculation.

Algorithms and the databases undergirding such algorithms are adapted to provide sufficient flexibility to meet varying time and accuracy budgets of users. Thus, the user has the ability to input as little or as much information as it elects.

Because the material conditions of each purchase are far too varied, calculation methodology cannot be described across all potential behavioral, action and purchase decisions, though certain principles and practices are ever present. A few descriptions may help clarify the principles and practices expressed through the Personal Energy Advisor.

For example, under the cooling reductions 154 of the Home Footprint, a determination of the impact of the user's decision to install a ceiling fan in a room instead of using a window air conditioning unit begins by describing the benefits of such an installation (e.g. a ceiling fan can make the room feel up to 7 degrees cooler) and sources of any data relied upon or manipulated by the system (in this case, data from the EPA and Columbia University). The system then asks the user to input the comfort temperature above which they wish to cool their room (a default value of 72 degrees F. applies if the user elects not to input a value), the number of hours they cool their room per day on days above their comfort temperature (default value of 9, derived from Columbia University data), the energy efficiency ratio of the window air conditioning unit (default value of 9.8, representing the market average) and the cooling capacity of the window air conditioning unit (default value of 10,000 BTU representing the market average).

The system then uses the user's zip code and queries a database in the Energy Mapping Software to retrieve the climate division associated with that zip code. It then proceeds to examine a list of 345 weather stations located in uniquely characterized climate division regions all around the United States to determine which one is associated with the user's zip code. It then retrieves the temperatures for every day over the last five years at the weather station closest to the user's address to determine the number of days less than two degrees, two to four degrees, four to seven degrees, or more than seven degrees above the user's comfortable temperature. These values correspond to the number of days the user would have to run the fan on low, medium, or high respectively, or to use an air conditioning unit instead of the fan, as occurs when the temperatures are more than seven degrees above the comfort temperature and the fan cannot provide enough cooling to be viable. The number of days in each of these categories is divided by five to determine the average number of days per year for each.

The system may next uses the energy use of various replacement fans in a list of products created to generate user-specific results for a number of different competing products. For each fan, the carbon dioxide emissions reduction, electricity use reduction, cost, and savings (relativized to the cost of using the air conditioning unit) are calculated. The electric reduction 162 is then calculated based on the average hourly electricity use of the user's current air conditioning unit minus the expected electricity use of the various replacement fan options on low, medium, and high based on their expected use pattern from the daily temperature data described above. The carbon reduction is calculated based on the electricity savings and the direct and indirect emission factors of the subregional grid in which the user resides via the same methodology described above in the home footprint component 128 of the footprint calculator description set forth above in connection with FIG. 2. Savings are calculated based on the electricity reduction and the latest monthly electricity prices for the user's state of residence or utility provider. Finally, the system uses the distribution of home heating degree days from the user's climate division across different months to estimate monthly dollars saved and carbon reduced. The user may elect to purchase a fan based on the associated carbon reduction, dollar savings, and cost associated with each.

Another example of a decision is to purchase a low-flow showerhead and the associated water heating reductions 152. To calculate the energy, water, carbon dioxide emission, and dollar savings associated with switching from a standard showerhead to a low-flow showerhead, the system takes into account the number of minutes per day the user spends showering, the fuel type of the user's current water heater (electricity, oil, or natural gas), the water heater type (storage or instantaneous), and the water heater age, all of which have default values representing average behaviors or product characteristics. The user may rely upon default values for shower temperature, water heater temperature, tap water temperature, and flow rate of their current showerhead based on market averages for these values. The user can elect to alter any of this information to produce a more reliable estimate by notifying the system of its water heater fuel, type, age and so on. Default values nonetheless provide a reasonably reliable estimate of actual values.

The system then determines the number of gallons of hot water (from the water heater) and cold water (from the tap) used in the user's daily shower based on the duration, temperature, water heater temperature, tap water temperature, and showerhead flow. It then determines the energy use per gallon of hot water used based on the water temperature and energy factor of the user's water heater queried from a manufacturer's database using the model number or other form of brand and model identification. Finally, it multiplies the energy use per gallon by the number of gallons of hot water used per year to determine the energy use of the user's current showerhead. The direct carbon dioxide emissions associated with this energy use are determined by multiplying the energy use by the carbon intensity of the user's electricity fuel mix and water heater fuel obtained from the EMS. The indirect carbon dioxide emissions associated with general water use are calculated using economic input-output lifecycle assessment tables.

The user is then presented with a number of potential product choices, each with an associated carbon dioxide emissions reduction, energy savings, water savings, cost savings, and product price. The system determines these values for each of the replacement showerheads by running simultaneous simulations and determining the difference between the current showerhead and the various potential replacements.

The present invention also includes a Personal Energy Advisor Savings Planner, which allows the user to set a goal of saving a particular amount each month on a fuel bill of their choice (electricity, natural gas, fuel oil, or propane) or across all bills. The user is provided with a list of recommended actions to meet this goal dynamically generated based on which actions have the highest cost-benefit ratio, with the user's choice of upfront cost preference (low, medium, high) affecting the discount rate used in creating the priority list. Each user receives distinct recommendations based on their initial energy use characteristics as determined by the Energy Mapping Software, as well as numerous other demographic and psychographic characteristics. Users can choose to remove suggested actions they do not want to undertake and are provided with a new list that fills in the removed action with one or more replacement actions. Users can also personalize suggested actions with specific energy use behavioral characteristics, which will also add or remove other actions from the recommendation list as needed to maintain the user's stated savings goal.

Thus, the Personal Energy Advisor is a personalized greening advisor that enables its users to determine precisely how much different behaviors, actions and products will affect climate change and their respective spending budgets. The examples provided herein are representative only. The Personal Energy Advisor currently includes hundreds of distinct behaviors, actions and purchases at the consumer and organizational level spanning thousands of products and many thousands of inputs.

The algorithms and databases that constitute the Personal Energy Advisor are too numerous to mention herein, but five examples will illustrate to those skilled in the art how the method is implemented. The following models relate to the impact of: closing your window blinds during the summer; running fewer clothes washer cycles by fully loading the washer; lowering the water temperature for dishwashers; replacing single pane windows with double pane ones; and cleaning lint filters in clothes dryers before each load.

### 1. “Blind_Summer”

### Description of Measure

Closing blinds for all the windows during summer days

### Input

Aₙₒᵣₜₕ=Total north-facing window area [ft²]

Aₛₒᵤₜₕ=Total south-facing window area [ft²]

Aₑₐₛₜ=Total east-facing window area [ft²]

A_{west}=Total west-facing window area [ft²]

T_{target}=Target thermostat temperature during the summer [° F.]

EER=EER value of the user's AC [BTU/Wh]
z=User's zip code

### Method for Calculating Energy Savings

### Net Annual Energy Savings:

NE[KWh/year]={(C_{before}−C_{after})+(R_{before}−R_{after})}/EER/1000,

where:

$$\begin{matrix}{C}_{before} = Condition heat gain through the window before closing \\ the blinds [ BTU \text{/} year ] \\ = A \cdot {\sum }_{i}^{when {T}_{avg , i} \geq {T}_{target}} ( {T}_{avg , i} - {T}_{target} ) \cdot \\ ( \frac{1}{{r}_{window} + {r}_{air , i} + {r}_{air , o}} ) \cdot 24\end{matrix}$$

A=Total window area [ft²]=Aₙₒᵣₜₕ+Aₛₒᵤₜₕ+Aₑₐₛₜ+A_{west}

T_{avg,i}=Average outdoor temperature for day i measured from the closest weather station from the user's zip code z [° F.] (Note 1)

$$\begin{matrix}{R}_{before} = Radiation heat gain through the window before \\ closing the blinds [ BTU \text{/} year ] \\ = ( \begin{matrix}{A}_{north} \cdot {\sum }_{summer} {e}_{north} + {A}_{south} \cdot {\sum }_{summer} {e}_{south} + \\ {A}_{east} \cdot {\sum }_{summer} {e}_{east} + {A}_{west} \cdot {\sum }_{summer} {e}_{west}\end{matrix} ) \cdot {g}_{window} \cdot {n}_{cd}\end{matrix}$$

e_{direction}=Daily average radiation per unit area on a vertical wall [BTU/ft²]/day] (Note 2)

g_{window}=Solar heat gain coefficient (SHGC) of user's window (0<g_{window}<1)

$$\begin{matrix}{n}_{c d} = Number of home cooling days per year [ day ] \\ = {\sum }_{when {T}_{avg} \geq {T}_{target}} 1\end{matrix}$$

$$\begin{matrix}{C}_{after} = Conduction heat gain through the window after \\ closing the blinds [ BTU \text{/} year ] \\ = A \cdot {\sum }_{i}^{when {T}_{avg , i} \geq {T}_{target}} ( {T}_{avg , i} - {T}_{target} ) \cdot \\ ( \frac{1}{{r}_{window} + {r}_{air , i} + {r}_{air , o} + {r}_{blind} + {r}_{airgap}} ) \cdot 24\end{matrix}$$

$$\begin{matrix}{R}_{after} = Radiation heat gain through the window after \\ closing the blinds [ BTU \text{/} year ] \\ = ( \begin{matrix}{A}_{north} \cdot {\sum }_{summer} {e}_{north} + {A}_{south} \cdot {\sum }_{summer} {e}_{south} + \\ {A}_{east} \cdot {\sum }_{summer} {e}_{east} + {A}_{west} \cdot {\sum }_{summer} {e}_{west}\end{matrix} ) \cdot \\ {g}_{window} \cdot {g}_{blind} \cdot {n}_{c d}\end{matrix}$$

g_{blind}=Solar heat gain coefficient (SHGC) of user's blind (0<g_{blind}<1)

r_{window}=Thermal resistance of the window [ft²·° F.·h/BTU]

r_{blind}=Thermal resistance of the blind [ft²·° F.·h/BTU]

r_{air,i}=Thermal resistance of the vertical air film inside the window [ft²·° F.·h/BTU]

r_{air,o}=Thermal resistance of the vertical air film outside the window [ft²·° F.·h/BTU]

r_{airgap}=Thermal resistance of the vertical air film between the blind and the window [ft²·° F.·h/BTU]

### Baseline Assumptions and Default Values

1) The sum of difference over a day between T_{target} and outside temperature is not much different from the difference between T_{target} and T_{avg} times 24.

$$2 ) {r}_{window} = \{ \begin{matrix}0.95 , & for single \text{-} pane window \\ 2.0 , & for double \text{-} pane window\end{matrix} \qquad ( Note 3 )$$

3) r_{air,i}=0.68 [ft·° F.·h/BTU] (Note 4)

r_{air,o}=0.25 [ft·° F.·h/BTU]

r_{airgap}=1.1 [ft·° F.·h/BTU]

4) r_{blind}=1.2 [ft·° F.·h/BTU] (Note 5)

$$5 ) {g}_{window} = \{ \begin{matrix}0.72 , & for single \text{-} pane window \\ 0.50 , & for double \text{-} pane window\end{matrix} \qquad ( Note 6 )$$

6) g_{blind}=0.3 (Note 7)

### Monetary Savings

Net Annual Monetary Savings[$/year]=NE·P_{i,fuel}

where:
P_{i,fuel}=Price of fuel (gas, oil, or electricity) in the region where user i lives.

### Carbon Savings

Net Annual Carbon Savings[lb/year]=NE·efᵢ

where:
efᵢ=Emission factor of the fuel (gas, oil, or electricity) in the region where user i lives.

### Notes

1. NOAA National Weather Service Climate Prediction Center Degree Day Data
2. The Solar Radiation Data Manual for Buildings, National Renewable Energy Laboratory (NREL), http://rredc.nrel.gov/solar/pubs/bluebook/
3. Windows for High Performance Commercial Buildings, University of Minnesota and Lawrence Berkeley National Laboratory, http://www.commercialwindows.umn.edu/images/2_{—}10.jpg
4. Energy Conservation Myths, The University of Texas at Austin, http://utwired.engr.utexas.edu/conservationMyths/heatingCooling/drapeDefense.cfm
5. Blind Shop LLC, http://www.blindshopaz.com/rfactors.html
6. Home Energy Magazine, http://www.homeenergy.org/archive/hem.dis.anl.gov/eehem/picts/00091701.gif
7. The Blind Spot, http://www.theblindspot.biz/energy-efficiency.htm

### 2. “Clothes_Washer_Reduce”

### Description of Measure

Running fewer clothes washer cycles by fully loading the tub

### Inputs

v_{tub}=Tub capacity of clothes washer [ft³] [symbol]
n=Times that users will reduce by this commitment [cycle/week]
a_{w}=Age of current water heater [year]
a_{c}=Age of current clothes washer [year]
T_{w}=Target temperature of water heater [° F.]
m_{wash}=Operation mode of wash cycle (hot, warm, or cold)
mᵣᵢₙₛₑ=Operation mode of rinse cycle (hot, warm, or cold)

### Method for Calculating Energy Savings

### Net Annual Energy Savings:

NE[KWh/year]=(w_{c}·rₕₒₜ·e_{w}+e_{c})· [symbol] n·52.18

where:

$$\begin{matrix}{w}_{c} = Water use by the clothes washer per cycle \\ [ gallons \text{/} cycle ] \\ = 10.85 \cdot ( 1 + 0.099 \cdot {a}_{c} ) \cdot {v}_{tub}\end{matrix} \\ \begin{matrix}{r}_{hot} = Proportion of hot water directly from the water \\ heater to total water used \\ = \frac{{p}_{wash} + {p}_{rinse}}{2}\end{matrix} \qquad ( Note 1 )$$

pᵢ=Ratio of hot water used for each cycle (i=wash or rinse)

$$\begin{matrix}{e}_{w} = Energy needed to heat a gallon of water to {T}_{w} [ BTU \text{/} gallon ] \\ = \frac{{H}_{w} \cdot ( {T}_{w} - {T}_{tap} )}{{ef}_{w}}\end{matrix}$$

Tₜₐₚ=Temperature of unheated tap water [° F.]
H_{w}=Specific heat of water [BTU/° F./gallon]
ef_{w}=Efficiency of the water heater
e_{c}=Energy use per clothes washer cycle [Kwh/cycle]=0.09018·(1+0.099·a_{c}) (Note 1)

### Baseline Assumptions and Default Values

### 1) Tₜₐₚ=58 [° F.]

2) ef_{w}=[0.90, 0.90, 0.90, 0.88, 0.84, 0.84, 0.84, 0.84, 0.84] for electric water heater (Note 2)

or [0.60, 0.60, 0.57, 0.54, 0.49, 0.49, 0.49, 0.49, 0.49] for gas water heater (Note 2)

or [0.70, 0.70, 0.67, 0.51, 0.47, 0.47, 0.47, 0.47, 0.47] for fuel oil water heater (Note 2)

Data in 5-year increments

$$3 ) {p}_{i} = \{ \begin{matrix}0 , & {m}_{i} = cold \\ 0.5 , & {m}_{i} = warm \\ 1 , & {m}_{i} = hot\end{matrix}$$

4) Assume that clothes washers use the same amount of water for wash and rinse cycles.

### Default Values for User Inputs:

v_{tub}=3.5 [ft³] [symbol]
n=2 [cycle/week]
a_{w}=10 [year]
a_{c}=6 [year]

### T_{w}=135 [° F.]

### M_{wash}=hot

Mᵣᵢₙₛₑ=warm

### Monetary Savings

Net Annual Monetary Savings[$/year]=NE·P_{i,fuel}

where P_{i,fuel}=Price of fuel (gas, oil, or electricity) in the region where user i lives.

### Carbon Savings

Net Annual Carbon Savings[lb/year]=NE·efᵢ

where efᵢ Emission factor of electricity in the region where user i lives.

### Notes

1. Energy Consumption of Major Household Appliances, Trends for 1990-2005, Natural Resources Canada
2. Data from EPA Energy Star and The Effect of Efficiency Standards on Water Use and Water Heating Energy Use in the U.S.: A Detailed End-use Treatment by Jonathan G. Koomey, Camilla Dunham, and James D. Lutz, 1994

### 3. “Dish_Washer_Temperature”

### Description of Measure

Lowering the water temperature for dishwashers

### Inputs

T_{before}=Original water temperature of dishwasher [° F.]

T_{after}=Target water temperature of dishwasher [° F.]
a_{d}=Age of the old dishwasher to be replaced [year]
n=Average times of dishwasher use per week [cycle/week]
a_{w}=Age of current water heater [year]
T_{w}=Target temperature of water heater [° F.]

### Method for Calculating Energy Savings

### Net Annual Energy Savings:

NE[KWh/year]=Eᵢₙₜₑᵣₙₐₗ+Eₑₓₜₑᵣₙₐₗ

where:

$$\begin{matrix}{E}_{external} = Energy saved by using less hot water from \\ external electric water heater [ KWh \text{/} year ] \\ = ( {r}_{before} - {r}_{after} ) \cdot {w}_{d} \cdot {e}_{w} \cdot n \cdot 52.18\end{matrix}$$

where

$$\begin{matrix}{r}_{before} = Proportion of hot water directly from the water heater \\ to total water used for dishwashing before lowering the \\ temperature \\ = \frac{min ( {T}_{before} , {T}_{w} ) - {T}_{tap}}{{T}_{w} - {T}_{tap}}\end{matrix}$$

Tₜₐₚ=Temperature of unheated tap water [° F.]

$$\begin{matrix}{r}_{after} = Proportion of hot water directly from the water heater \\ to total water used for dishwashing after lowering the \\ temperature \\ = \frac{min ( {T}_{after} , {T}_{w} ) - {T}_{tap}}{{T}_{w} - {T}_{tap}}\end{matrix}$$

w_{d}=Water use by the dishwasher per cycle [gallon/cycle] 4.6415·e_{d}−1.9295 (Note 3)
e_{d}=Energy per dishwasher cycle [KWh/cycle]

$$\begin{matrix}{e}_{w} = Energy needed to heat a gallon of water to {T}_{w} [ BTU \text{/} gallon ] \\ = \frac{{H}_{w} \cdot ( {T}_{w} - {T}_{tap} )}{{ef}_{w}}\end{matrix}$$

H_{w}=Specific heat of water [BTU/° F./gallon]
ef_{w}=Efficiency of the water heater
Eᵢₙₜₑᵣₙₐₗ=Energy saved by heating less water with the boost heater inside the dishwasher [Kwh/year]=w_{d}·e_{b}·n·52.18

$$\begin{matrix}{e}_{b} = Energy needed for the boost heater to heat a gallon \\ of water [ BTU \text{/} gallon ] \\ = {H}_{w} \cdot \{ max ( {T}_{before} , {T}_{w} ) - max ( {T}_{after} , {T}_{w} ) \}\end{matrix}$$

### Baseline Assumptions and Default Values

1) e_{d}=[5.58, 6.28, 7.06, 7.86, 8.35, 8.39, 8.42, 8.50, 8.53, 8.75, 8.78, 10.03, 11.58, 11.64, 12.18, 12.97] [MJ/cycle] for different age of dishwashers starting from age of 0 (Note 1)
This value includes energy needed both for running the machine itself and for heating water.
   2) ef_{w}=[0.90, 0.90, 0.90, 0.88, 0.84, 0.84, 0.84, 0.84, 0.84] for electric water heater (Note 2)

or [0.60, 0.60, 0.57, 0.54, 0.49, 0.49, 0.49, 0.49, 0.49] for gas water heater (Note 2)

or [0.70, 0.70, 0.67, 0.51, 0.47, 0.47, 0.47, 0.47, 0.47] for fuel oil water heater (Note 2)

Data in 5-year increments

### 3) Tₜₐₚ=58 [° F.]

4) Assume that efficiency of boost heater inside dishwashers can be considered as 1.

### Default Values for User Inputs:

### T_{before}=140 [° F.]

### T_{after}=120 [° F.]

a_{d}=⁷ [year]
n=4 [cycle/week]
a_{w}=10 [year]

### T_{w}=135 [° F.]

### Monetary Savings

Net Annual Monetary Savings[$/year]=NE·P_{i,fuel}

where P_{i,fuel}=Price of fuel (gas, oil, or electricity) in the region where user i lives.

### Carbon Savings

Net Annual Carbon Savings[lb/year]=NE·efᵢ

where efᵢ=Emission factor of electricity in the region where user i lives.

### Notes

1. Energy Consumption of Major Household Appliances Shipped in Canada—Trends for 1990-2005, Natural Resources Canada, http://oee.nrcan.gc.ca/Publications/statistics/cama07/index.cfm
2. Data from EPA Energy Star and The Effect of Efficiency Standards on Water Use and Water Heating Energy Use in the U.S.: A Detailed End-use Treatment by Jonathan G. Koomey, Camilla Dunham, and James D. Lutz, 1994
3. Regression based on data from “Energy and Water Use Determination” by U.S. DOE Energy Efficiency and Renewable Energy (EERE), http://www.eere.energy.gov/buildings/appliance_standards/residential/pdfs/home_appliances_tsd/chapter_{—}6.pdf

### 4. “Double_Pane_Window”

### Description of Measure

Replacing single pane windows with double pane ones

### Input

type=Type of users' windows=[aluminum, aluminum with thermal break, wood/vinyl, or insulated] (Note 1)
Aₙₒᵣₜₕ=Total north-facing window area [ft²]
Aₛₒᵤₜₕ=Total south-facing window area [ft²]
Aₑₐₛₜ=Total east-facing window area [ft²]
A_{west}=Total west-facing window area [ft²]
Tₛᵤₘₘₑᵣ=Target thermostat temperature during the summer [° F.]
T_{winter}=Target thermostat temperature during the winter [° F.]
EER=EER value of the user's AC [BTU/Wh]
z=User's zip code

### Method for Calculating Energy Savings

### Net Annual Energy Savings:

NE[KWh/year]={(C_{summ,s}−C_{summ,d})+(R_{summ,s}−R_{summ,d})}/EER/1000+{(C_{wint,s}−C_{wint,d})+(R_{wint,s}−R_{wint,d})}/efₕₑₐₜₑᵣ,

where:

$$\begin{matrix}\begin{matrix}{C}_{season , s} = Conduction heat gain or loss through the single \\ pane window during that season [ BTU \text{/} year ] \\ = A \cdot {\sum }_{i}^{when {T}_{avg , i} \geq {T}_{summer}} ( {T}_{avg , i} - {T}_{summer} ) \cdot \frac{1}{{r}_{total}} \cdot 24 ( summer )\end{matrix} & \\ or & \\ A \cdot {\sum }_{i}^{when {T}_{avg , i} \leq {T}_{winter}} ( {T}_{winter} - {T}_{avg , i} ) \cdot \frac{1}{{r}_{total}} \cdot 24 ( winter ) & \end{matrix}$$

C_{season,d}=Conduction heat gain or loss through the double pane window during that season [BTU/year]
A=Total window area [ft²]=Aₙₒᵣₜₕ+Aₛₒᵤₜₕ+Aₑₐₛₜ+A_{west}
T_{avg,i}=Average outdoor temperature for day i measured from the closest weather station from the user's zip code z [° F.] (Note 1)

$$\begin{matrix}{R}_{season , s} = Radiation heat gain through the single pane window \\ [ BTU \text{/} year ] \\ = ( \begin{matrix}{A}_{north} \cdot {\sum }_{season} {e}_{north} + {A}_{south} \cdot {\sum }_{season} {e}_{south} + \\ {A}_{east} \cdot {\sum }_{season} {e}_{east} + {A}_{west} \cdot {\sum }_{season} {e}_{west}\end{matrix} ) \cdot \\ {g}_{single} \cdot {g}_{blind} \cdot {n}_{cd or hd}\end{matrix}$$

R_{season,d}=Radiation heat gain through the double pane window [BTU/year]
e_{direction}=Daily average radiation per unit area on a vertical wall [BTU/ft²]/day] (Note 2)
g single=Solar heat gain coefficient (SHGC) of single pane window

$$\begin{matrix}\begin{matrix}{n}_{c d or hd} = Number of home cooling / heating days per year [ day ] \\ = {\sum }_{when {T}_{avg} \geq {T}_{summer}} 1 ( cooling )\end{matrix} & \\ or & \\ {\sum }_{when {T}_{avg} \leq {T}_{winter}} 1 ( heating ) & \end{matrix}$$

g_{blind}=Solar heat gain coefficient (SHGC) of user's blind (0≦g_{blind}≦1)

$${r}_{total} = \{ \begin{matrix}{r}_{window} + {r}_{air , i} + {r}_{air , o} , & when blinds are used \\ {r}_{window} + {r}_{air , i} + {r}_{airgap} + {r}_{air , o} + {r}_{blind} , & when blinds are not used\end{matrix}$$

r_{window}=Thermal resistance of the window [ft²·° F.·h/BTU]
r_{blind}=Thermal resistance of the blind [ft²° F.·h/BTU]
r_{air,i}=Thermal resistance of the vertical air film inside the window [ft²° F.·h/BTU]
r_{air,o}=Thermal resistance of the vertical air film outside the window [ft²° F.·h/BTU]
r_{airgap}=Thermal resistance of the vertical air film between the blind and the window [ft²·° F.·h/BTU]

### Baseline Assumptions and Default Values

1) The sum of difference over a day between T_{target} and outside temperature is not much different from the difference between T_{target} and T_{avg} times 24.

$$2 ) {r}_{window} = \{ \begin{matrix}0.86 , 1.0 , 1.19 , & for single \text{-} pane window \\ 1.35 , 1.59 , 2.04 , 2.27 , & for double \text{-} pane window\end{matrix} \qquad ( Note 3 )$$

(for aluminum, aluminum w/thermal break, wood/vinyl, insulated type respectively)

Windows with low-e coating are also taken into account.

3) r_{air,i}=0.68 [ft·° F.·h/BTU] (Note 4)

r_{air,o}=0.25 [ft·° F.·h/BTU]

r_{airgap}=1.1 [ft·° F.·h/BTU]

4) r_{blind}=1.2 [ft·° F.·h/BTU] (Note 5)

$$5 ) {g}_{window} = \{ \begin{matrix}0.76 , 0.70 , 0.63 , & for single \text{-} pane window \\ 0.67 , 0.62 , 0.56 , 0.60 , & for double \text{-} pane window\end{matrix} \qquad ( Note 3 )$$

6) g_{blind}=0.3 (Note 7)
7) efₕₑₐₜₑᵣ=[0.80, 0.80, 0.78, 0.76, 0.68, 0.68, 0.65, 0.60, 0.60] for gas furnace (Note 8)
or [0.80, 0.80, 0.80, 0.80, 0.75, 0.72, 0.65, 0.65, 0.65] for oil furnace
or [0.98, 0.98, 0.97, 0.97, 0.96, 0.96, 0.95, 0.95, 0.94] for electric furnace
Data in 5-year increments

### Monetary Savings

Net Annual Monetary Savings[$/year]=NE·P_{i,fuel}

where P_{i,fuel}=Price of fuel (gas, oil, or electricity) in the region where user i lives.

### Carbon Savings

Net Annual Carbon Savings[lb/year]=NE·efᵢ

where efᵢ=Emission factor of the fuel (gas, oil, or electricity) in the region where user i lives.

### Notes

1. NOAA National Weather Service Climate Prediction Center Degree Day Data
2. The Solar Radiation Data Manual for Buildings, National Renewable Energy Laboratory (NREL), http://rredc.nrel.gov/solar/pubs/bluebook/
3. RESFEN—LBNL Window & Daylighting Software
4. Energy Conservation Myths, The University of Texas at Austin, http://utwired.engr.utexas.edu/conservationMyths/heatingCooling/drapeDefense.cfm
5. Blind Shop LLC, http://www.blindshopaz.com/rfactors.html
6. Home Energy Magazine, http://www.homeenergy.org/archive/hem.dis.anl.gov/eehem/picts/00091701.gif
7. The Blind Spot, http://www.theblindspot.biz/energy-efficiency.htm
8. EPA Energy Star furnace efficiency calculator, http://www.energystar.gov/index.cfm? c=furnaces.pr_furnaces

### 5. “Dryer-Lint_Filter”

### Description of Measure

Cleaning lint filters in clothes dryers before each load to increase their efficiency

### Inputs

r=How often users cleaned the filters before (i.e. once per every r loads) [/load]
n=Average number of dryer runs per week [load/week]

### Method for Calculating Energy Savings

### Net Annual Energy Savings:

NE[Kwh/year or Therm/year]=E_{dryer}·rₜᵢₘₑ·n·52.18,

where:
E_{dryer}=Energy use of the clothes dryer per load [KWh/load]

$$\begin{matrix}{r}_{time} = Average percentage of time which can be saved by \\ cleaning filters \\ = \frac{r}{10} \cdot \frac{1}{2} \cdot 0.3 ,\end{matrix}$$

$$when r < 10$$

$$or$$

$$\frac{\{ \frac{1}{2} \cdot 10 + ( r - 10 ) \} \cdot 0.3}{r} , when r >= 10$$

### Baseline Assumptions and Default Values

### 1) E_{dryer}=1.8352 [KW] (Note 2)

### or 0.0626 [Therm] (Note 2)

2) One load means one running cycle of the dryer machine.
3) Inefficiency due to the dirty filter increases proportionally per each cycle and reaches its maximum of 30% after running 10 cycles. rₜᵢₘₑ is the average value over the user's cleaning period. (Note 1)

### Default Values for User Inputs:

r=5[/load]
n=2 [load/week]

### Monetary Savings

Net Annual Monetary Savings[$/year]=NE·P_{i,fuel}

where P_{i,fuel}=Price of fuel (gas, oil, or electricity) in the region where user i lives.

### Carbon Savings

Net Annual Carbon Savings[lb/year]=NE·efᵢ

where efᵢ=Emission factor of electricity in the region where user i lives.

### Notes

1. California Energy Commission, Consumer Energy Center, http://www.consumerenergycenter.org/home/appliances/dryers.html
2. Based on personal communication with Bill McNary at D&R International, Ltd. and EPA Energy Star dryer database.

The Personal Energy Advisor provides a comprehensive, high-resolution and helpful process for quantifying and reducing global warming impact throughout an individual or business's life span.

The system may run all EMS and Personal Energy Advisor calculations for simultaneous outputs any time any value is modified in either the EMS or Personal Energy Advisor. The simultaneous outputs include but are not limited to: carbon dioxide emissions and equivalences in other greenhouse gases, energy, fuel oil, gasoline, jet fuel, natural gas, electricity, water, paper, dollars saved, upfront cost, and others. The system filters and sums the simultaneous outputs of all EMS algorithms into the four categories and various subcategories. The system performs the same process for the Personal Energy Advisor algorithms, the outputs of which are distributed to four categories and the various subcategories corresponding to those of the EMS. The system subtracts each Personal Energy Advisor subcategory from the corresponding EMS subcategory to yield the subcategory outputs. In the event that the Personal Energy Advisor subcategory value is greater than the EMS subcategory value, the subcategory is set as null for any of the simultaneous outputs. Each Personal Energy Advisor subcategory is then aggregated at the category level to yield four category reduction values for each of the simultaneous outputs. Each subcategory is aggregated at the category level to yield four category footprint values for each of the simultaneous outputs. Each Personal Energy Advisor category is then aggregated to yield a total reduction value for each of the simultaneous outputs. The system undergoes the same process for each of the categories to yield a total footprint value for each of the simultaneous outputs.

The footprint value can be offset by purchasing additional, verifiable renewable energy or energy efficiency credits. The quantity of renewable energy capacity created or energy demand and carbon dioxide emissions saved is calculated and utilized to determine the user's “distance” from carbon neutrality. The system is responsible for the interaction between offset and footprint values, though it appears that the Personal Energy Advisor is responsible for this interaction on the Web Site provided in accordance with the present invention. The system incorporates energy use and carbon dioxide emission offsets to maximize the ability of consumers and organizations to influence a transition towards a sustainable future. The user is able to view its initial footprint, current footprint, reductions, offsets, and quantity away from carbon neutrality for each of the simultaneous outputs and any combination of them.

The system runs various other processes besides the subcategory interaction linking baseline usage, reductions and offset values in order to maximize accuracy and customizability for the user. It should be appreciated that, due to the interaction of the algorithms involved, each input may change more than one value in more than one subcategory or category in either the Personal Energy Advisor or the EMS. For example, if a user commits to install solar panels on their rooftop, this installation will change the emission factor associated with electricity use in the user's home. Any actions or purchases that reduce home electricity use will be updated automatically to take into account this change in emission factors, thereby maintaining the overall accuracy of reduction calculations. Because the EMS and the Personal Energy Advisor interact with one another through a set of feedback mechanisms defined in the system, the high-resolution character of the Personal Energy Advisor outputs is not countervailed by even the lowest user engagement levels with the EMS.

In addition, the reduction in the user's carbon footprint and energy use that is determined based on an input value or a change in a previously input value may be capped based on a subcategory allowance. For example, if the user indicates that the user has replaced all light bulbs in the home with energy saving bulbs, the reduction in the carbon footprint may be capped by the allowance provided for the home appliance category. This minimizes the influence of human error by preventing a user from indicating more savings in a specific subcategory than was previously determined by algorithms comprising that subcategory. Thus, Personal Energy Advisor subcategory outputs are limited in their ability to change the aggregate category and total outputs.

The system also dynamically updates the user's initial footprint when the user inputs information into EMS or Personal Energy Advisor algorithms that provide more specific information than those currently stored in the footprint. For example, if the user initially indicates that they use a natural gas water heater to heat their water and does not provide further information, the system assigns that gas water heater an efficiency rating based on the average natural gas water heater currently on the market and the average age of water heaters installed in similar house types in the user's region. The user may later install a low flow showerhead and indicate at that time the specific age of the water heater in the home. If the age of the water heater input in the Personal Energy Advisor algorithm differs from the one used in the EMS algorithm, the value in the EMS algorithm will be updated, either by being replaced or being proportionally raised or reduced, depending on the circumstance. Thus, the more behavioral changes and purchases the user makes, the more the system learns and adapts to supplement and refine the user's EMS profile. The system thus gives the EMS and Personal Energy Advisor a lens on the entire set of data stored for any particular user and thereby enables each to make the other more precise, customized and user-friendly.

The system also accounts for a host of complex interactions between the EMS and various actions, purchases and behavioral changes. For example, if a user commits to install a new high-efficient natural gas fired hot water heater, this will change the emission reductions of any prior hot water-related actions undertaken by the user. If the user in question has already installed low flow showerhead, replacing the water heater reduces the carbon emissions obtained from the low flow showerhead purchase. By tracking over sixty key variables in the user's profile, such as water heater age and fuel type, the present invention is able to account for the entire range of potential interactions between energy end-use characteristics, behavioral changes, actions and purchases to adjust the simultaneous outputs. The system thus unites the EMS and the Personal Energy Advisor to create a comprehensive energy use and carbon dioxide emissions monitor, customized greening advisor and tracking system, and personalized e-commerce platform.

III. Community Connect

Community Connect is a consumer- and enterprise-facing suite of software applications designed to engage consumers and businesses around energy use and their physical communities in a variety of interesting ways. Community Connect consists of the following interfaces:

Dashboard. Dynamic user dashboard that provides updates on products, friends, neighborhood events, groups, messages (including real-time chat with friends or service representatives) and other relevant information.

Energy Displays. Customer-friendly online displays that visualize estimated breakdowns of electricity usage by category (A/C, lighting, etc.).

Savings Plan. Intuitive interface that sorts and displays over 300 custom product and action recommendations tailored to customers' preferences and energy end use profile; customers set savings goals and receive customized savings plan; feedback given by comparing current and past bills to savings targets, accounting for temperature and other changes.

Profile. Robust user identity that visualizes peer group comparisons, total bill and resource savings, personal information, recent actions and other social information relevant to the customer (message boards, blogs, events, etc.)

Neighborhood. Community interface that leverages advanced geo-location software with billing analytics and the Personal Energy Advisor to provide usage and savings comparisons for similar homes and neighbors; customers can become friends with their neighbors, seeing what actions they are taking to save energy and then recommend actions and challenge them to reduce energy.

People. Searchable database of CUB customers that are utilizing the Community Connect SM software; searches can be done by name, neighborhood and gender; customers can friend other customers.

Groups. Searchable database of groups created by CUB customers, including automatic networks related to neighborhoods.

Account Settings. Customer-friendly interface to manage privacy, password and other relevant account settings.

Contests page. End users can compete against one another in a host of contests around reducing energy use and carbon footprints.

Those skilled in the art will appreciate that the Community Connect functionality provided in connection with the present invention may be implemented on the system shown in FIG. 1. For example, the interfaces described above may be presented as a user interface 12 accessed via a web site available over the network 16 via the user workstation 10.

The following list describes a few exemplary features of the Community Connect portion of the present invention:

Goal-based interfaces. Energy and carbon savings tools that translate general goals into specific, personalized actions. In addition to receiving personalized savings plans, customers can rank possible actions by nine distinct metrics, including dollars saved, upfront costs, carbon, electricity, natural gas, water, paper and gasoline.

Online community. Robust online community features include activity feeds, a messaging service, blogs, automated inviter applications, groups, contests, events, and real-time chat. All of these tools are adapted to maximize the potential for energy and carbon reductions.

E-commerce platform. A user's customers can easily compare and contrast specific energy efficient products and services. Rebates, coupons and other incentives can also be linked to specific products and services.

Geocoding. Geographic location tools that connect users with each other and energy efficiency products and services. Customers can discover where they can find the nearest green building or energy auditor while connecting with their co-worker for a carpool.

Content integration. Targeted content is a crucial component to engagement. The software is built to integrate content easily and also provide custom content from the editorial team.

Complementary social media tools. Facebook, iPhone, Twitter, and other relevant social media applications that link actions on the Website to the rest of the social web.

Contests platform. A user's customers, their neighborhoods, towns and companies can create contests around specific actions to reduce energy use, set contest deadlines and judges, and the software automatically tracks and ranks the participants in the contest, announcing a winner at the contest deadline.

IV. Climate Culture Virtual World Game and Social Network

The Climate Culture Virtual World (CCVW) is a virtual networked environment and social network that mirrors the actual global warming impact of the individual or organization and creates a fully immersive competitive and collaborative experience among consumers, among organizations, and between consumers and organizations for the purpose of minimizing human impact on climate change. By providing a link between virtual and real worlds, it creates a new process for engaging a consumer or business to understand and decrease its global warming impact.

Like the Community Connect functionality discussed above, the CCVW functionality can be implemented on the system shown in FIG. 1.

The CCVW is inhabited by a customizable avatar that can resemble its real-world user. The avatar guides the user step-by-step through the process of reducing the user's global warming impact. The system enables the CCVW to customize its recommendation system based on the characteristics of the specific user. Actions taken in the CCVW, such as travel, car choice, shopping purchases, or job selection provide guidance for helping a user to reduce global warming in the real world. A specific percentage of carbon dioxide reduced from the user's baseline footprint earns the user a specific number of experience points in the virtual world. The number of points a user accumulates determines the user's level and status in the virtual world and provides the user with access to different features, such as avatar customization options and digital assets in the virtual world.

The virtual world environment contains no less than thirty components each with up to seven 3D representations. Hundreds of graphical components maximize the ability of the virtual world to differentiate between the diverse energy end-use characteristics of users. The components of the virtual world may include but are not limited to: home, apartment complex, mobile home, office, manufacturing facility, primary school, secondary school, college or university, strip mall, farmer's market, indoor shopping mall, community center, contests arena, amusement park and game center, airport, train station, subway, virtual store, coal plant, oil well, natural gas plant, wind farm, solar panel farm, reduction center, forest, lake, beach, triumphal arch, space needle, bio dome, air tram, catamarans, dolphins, whale, modern schooner, birds, hand glider, eagle, plane glider, ferry, canoes, hot air balloon, rainbow, and others. Each of these components reflects the user's carbon dioxide or other resource footprint or the amount of carbon dioxide emissions or other resources the user has reduced.

The virtual world reflects the carbon footprint of the user in absolute terms, meaning that certain features of the user's footprint may be relatively beyond the user's control. For instance, if the user lives in a state that relies significantly upon coal-based sources of electricity, the user may have great difficulty upgrading the user's home, office and coal plant based on geographic location alone. However if the user lives in a geographic area that primarily relies upon clean sources of electricity production, then the user's home, office and coal plant will likely be displayed in a more attractive manner.

This fact, referred to as the “West Virginia Problem,” supports the conclusion that social status should not be determined based on the absolute footprint values of the user. The CCVW therefore bases social status on the amount of experience points a user accrues. Experience points are primarily based on the amount the user has reduced its footprint as a percentage of its initial footprint, including any refinements thereto. There are also a number of other ways in which users can accrue experience points, including but not limited to playing games, taking part in contests, and making smart choices in terms of lifestyle behavioral changes, actions and purchases, and contests.

The number of experience points possessed by the user determines the user's level in the CCVW. The CCVW has no less than seven levels, each of which specifies a particular set of features and assets to which the user has access on the Web Site provided in accordance with the present invention. For instance, at higher levels, the user may enhance the user's avatar representation through a variety of fun and customizable digital assets.

The CCVW also creates a competition to quantify, reduce and verify global warming impact. The CCVW may also contain a market-leading social network whereby each major social network component, such as groups or events, is integrated with the Personal Energy Advisor. This integration enables, for instance, group members and leaders or event administrators and participants to learn from and adapt to a host of interesting data sets. The CCVW offers a host of features that integrate online community and energy advisory functions.

The CCVW may also enable consumers and organizations to engage in timed contests with quantifiable metrics over a wide range of actions. Any of the actions, purchases or behavioral changes, or combinations thereof, contained in the Personal Energy Advisor algorithms can be converted into a contest using technology embedded in the Personal Energy Advisor. Consumers, businesses, non-profit institutions, schools and similarly situated parties are empowered to compete in this contests environment.

For example, two major environmental organizations may compete to install the most compact fluorescent light bulbs in their facilities; the various dorms at a university can compete to reduce hot water usage in winter months; two rival law firms can compete to recycle the most aluminum and paper; two towns can compete to reduce tailpipe emissions by instituting a carpooling system. These examples are representative only and not intended to be exhaustive. The contests feature contains a number of various policing mechanisms, such as timing, attestation, file uploading, confirmation, invalidation and judging options, which enables the participants to elect the level of rigor with which their contest is tracked and judged.

The CCVW may also enable consumers and organizations to form groups. Groups may be loosely or closely affiliated individuals or entities, whether existing in only virtual or both virtual and physical space. The CCVW provides the same carbon dioxide monitoring and reduction service described above for individuals to groups of any kind. Groups are also able to engage in a wide range of tasks regarding connectivity between members, event planning, scheduling, outreach, and others. Representative examples of data sets related to groups may include total and average carbon footprint, most popular actions or purchases, total and average reductions, total and average dollars saved, group's progress over time, and others.

The CCVW may also enable the user to create or join groups, participate in one-time or recurring events, plan and outreach for events, share news and media regarding events, and connect with other members surrounding events. The events feature may be integrated into the Personal Energy Advisor such that the carbon footprint for the event can be automatically calculated by the number of event attendees, since the Personal Energy Advisor knows the location of all attendees, as well as the location of the event. Attendees may specify their means of transportation when they join the event or, alternatively, the event calculator uses default values based on location and distance traveled. For instance, if an attendee specifies a vehicle as the mode of transportation, the Personal Energy Advisor uses the make, model and year in the profile unless the user specifies otherwise.

The events feature thus serves as an automated carbon event calculator. At higher levels of sophistication, event participants may specify detailed information related to participation in the event, the scope of which expands beyond travel emissions and incorporates a variety of direct and indirect emissions related to event participation. The participants and/or administrator of the event thus has the option with a single click of the mouse to make the event carbon neutral by purchasing additional, renewable energy or energy efficiency credits.

The CCVW may rely on the Personal Energy Advisor to support organization accounts provided in accordance with the present invention. Organization account features provide a robust suite of services that assist organizations across a wide swath of sustainability needs, including but not limited to: market-leading carbon dioxide emission, energy and other resource usage inventories using the Personal Energy Advisor; a sustainability advisory tool based on a subset of algorithms that apply specifically to organizations and which are differentiated by sector and industry; an employee and/or green team forum to enable transparent, inclusive and cost/benefit-sensitive decision-making regarding how most effectively to reduce an organization's global warming impact (this feature relies on the sustainability advisory tool mentioned immediately above); consumer fan clubs enabling organizations to share their sustainability efforts, special offers and other useful information with users who opt in to the fan club; customized algorithms relating to specific products capable of determining the extent to which such products reduce carbon dioxide emissions or other resource usage more effectively than similar products.

A real-time multi-user game platform may also be provided in accordance with the present invention. The CCVW enables users to earn points by playing games that execute offsets donated by third-party sponsors. The more games the user plays, wins and the higher the score, the more offsets and points accrue to the user. A representative example of a multi-user game is “Scrubble.” Scrubble requires the user to combine at least three of the same molecules to scrub the sulfur dioxide, nitrous oxide and carbon dioxide emissions from a coal-based electricity generation facility. The user plays the role of a shooter under the clock who must scrub the emissions at a faster rate than others. Each time a user successfully executes a three (or four or five) molecule pairing, the molecules are transferred to the other players, thus making it more difficult for them to prevail. The amount of carbon dioxide scrubbed in the game is equated to a real-world value, which is then offset through the purchase of renewable energy or efficiency credits.

Other features that may be contained in the CCVW that create a collaborative and competitive experience to reduce global warming impact may include: an activity feed notifying users of friends' actions on the site, such as points accrued, carbon footprint reduced, events attended, avatars enhanced, and others; universal search for people, groups, events, contests, companies, organizations, forums; a robust marketplace wherein consumers recommend, filter and buy products based on their unique energy end-use preferences; and various statistical, tracking and visualization tools, such as an automated carbon dioxide emissions calculator for driving and other transport distances, among others.

It should now be appreciated that the present invention provides advantageous methods, apparatus, and systems for greenhouse gas footprint monitoring. As noted above, the present invention is applicable to individuals, families, groups of individuals, companies, buildings, homes, job sites and other entities.

Although the invention has been described in connection with various illustrated embodiments, numerous modifications and adaptations may be made thereto without departing from the spirit and scope of the invention as set forth in the claims.

What is claimed is:

1. A computerized method for determining greenhouse gas emissions and energy usage, comprising:
accepting user inputs specific to an end user;
correlating one or more of said user inputs with at least one of historic data and modeled characteristics pertaining to greenhouse gas emissions and energy usage to obtain at least one of greenhouse gas emissions and energy usage corresponding to said one or more of said user inputs; and
determining an overall greenhouse gas emissions and energy usage for said end user based on said greenhouse emissions and energy usage corresponding to said one or more of said user inputs.

2. A computerized method in accordance with claim 1, wherein said user inputs comprise details regarding at least one of home, work, travel, and consumption of goods.

3. A computerized method in accordance with claim 1, wherein:
said overall greenhouse gas emissions and energy usage comprise direct and indirect greenhouse gas emissions and energy usage;
said direct greenhouse gas emissions and energy usage account for a direct impact of at least one of actions taken by the end user and performance of products purchased by the end user; and
said indirect greenhouse gas emissions and energy usage corresponds to one or more of material sourcing, manufacture, distribution, retail, consumption and post-consumption of products purchased by the end user.

4. A computerized method in accordance with claim 1, further comprising:
providing home, work, shopping and travel categories of greenhouse gas emissions and energy usage;
enabling a selection of one or more of said categories; and
determining a portion of said overall greenhouse gas emissions and energy usage corresponding to said one or more selected categories;
wherein:
said portion of said overall greenhouse gas emissions and energy usage for said home category is based on at least one of water heating, space heating, space cooling and appliance information for said end user's home;
said portion of said overall greenhouse gas emissions and energy usage for said work category is based on at least one of electricity and natural gas information for said end user's work environment;
said portion of said overall greenhouse gas emissions and energy usage for said shopping category is based on at least one of food, alcohol, hotel, housing, healthcare, and miscellaneous expenditures and consumption information; and
said portion of said overall greenhouse gas emissions and energy usage for said travel category is based on at least one of vehicle, airplane, and miscellaneous transportation expenditures and information.

5. A computerized method in accordance with claim 4, wherein said user inputs for said home category comprise at least one of zip code, heating equipment type, cooling equipment type, heating fuel, water heater type, water heater size, water heater fuel, space heating equipment, space cooling equipment, age of heating and cooling equipment, residence type, residence construction material information, year of residence construction, square footage, number of rooms, number of heating degree days per year, number of cooling degree days per year, yearly household income, lighting type and usage information, home office equipment information, major appliance information, small appliance information, day and night thermostat settings, census division based on zip code, typical temperature setting for wash cycle of washing machine, stove fuel, number of people in residence, average monthly fuel usage, average monthly fuel cost, swimming pool information, spa information, number of televisions, number of computers, relative urbanity of area of home, aquarium information, separate freezer, water bed ownership characteristics.

6. A computerized method in accordance with claim 5, wherein:
said zip code input is linked to a corresponding weather location; and
energy usage corresponding to a default residence type for said corresponding weather location is determined based on historical weather patterns for said weather location;
said overall greenhouse gas emissions and energy usage is determined from the energy usage corresponding to the default residence type.

7. A computerized method in accordance with claim 6, further comprising mapping the zip code input to a regression analysis of at least one of current Department of Energy Residential Energy Consumption Survey data, National Climate Data Center Climate Division data, U.S. Census Data, American Housing Survey Data, public energy consumption data, and private energy consumption data.

8. A computerized method in accordance with claim 6, further comprising:
automatically obtaining specific residence information from computerized public records; and
refining said default residence type based on said specific residence information;
wherein said specific residence information includes at least one of residence type, square footage, year built, heating equipment type, cooling equipment type, fuel type, insulation type, number of rooms, and number of individuals in residence.

9. A computerized method in accordance with claim 6, wherein said overall greenhouse gas emissions and energy usage corresponding to said default residence type is modified based on other of said user inputs.

10. A computerized method in accordance with claim 5, wherein said overall greenhouse gas emissions and energy usage is subdivided into a plurality of home end-uses and an overall home footprint.

11. A computerized method in accordance with claim 4, wherein said user inputs for said home category include home fuel payment information.

12. A computerized method in accordance with claim 11, wherein said fuel payment information comprises fuel cost information, said method further comprising:
correlating said fuel cost information with a utility provider based on a database of utility providers for the end user's zip code;
obtaining up-to-date pricing information for said utility provider;
determining fuel usage based on said pricing information.

13. A computerized method in accordance with claim 12, wherein said fuel payment information is obtained automatically from online banking records or utility records.

14. A computerized method in accordance with claim 11, wherein:
said fuel payment information is linked to a database containing annual fuel use curves for a corresponding fuel type used in the residence; and
said annual fuel use curve is determined from historical weather and temperature characteristics in a weather location corresponding to the zip code.

15. A computerized method in accordance with claim 5, further comprising:
determining fuel usage by a simulation of fuel usage based on the zip code and at least one of the residence type, the heating equipment type, the cooling equipment type, the water heater type, the space heating equipment, the space cooling equipment, the major appliances, and the small appliances.

16. A computerized method in accordance with claim 15, wherein:
default inputs are provided for at least one of the residence type, the heating equipment type, the cooling equipment type, the water heater type, the space heating equipment, the space cooling equipment, the major appliances, and the small appliances; and
said default inputs are based on common types of equipment in the weather location.

17. A computerized method in accordance with claim 4, wherein said user inputs for said travel category comprise at least one of vehicle information, flight history information, vehicle rental information, taxi usage history, and public transportation usage habits.

18. A computerized method in accordance with claim 17, wherein:
yearly fuel consumption for each vehicle identified in said vehicle information is determined based on one of historical mileage data or user input actual mileage data for each of said identified vehicle; and
said yearly fuel consumption is converted to yearly greenhouse gas emissions for each vehicle using conversion factors for converting fuel type to carbon dioxide.

19. A method in accordance with claim 17, wherein:
said flight history information comprises one of: (a) specific flight information for each flight taken, including at least one of flight length, flight origin and destination, plane type, plane age, and layover information; and (b) estimate of number of flights taken and length of flights taken;
a flight class is determined for each flight based on the flight length;
carbon dioxide emissions are determined for each flight based on an emissions factor for the flight class and the flight length.

20. A computerized method in accordance with claim 4, wherein said user inputs for said work category comprise at least one of city, state, zip code, square footage, date of construction, number of floors, human capacity and usage, occupation, hours of operation, exterior materials, lighting, heating equipment type, space heating equipment type, cooling equipment type, space cooling equipment type, heating fuel, water heater type, water heater fuel, average monthly fuel usage, fuel usage per month, fuel payment history, electricity usage per month, and average electricity usage per month.

21. A computerized method in accordance with claim 20, wherein said user input further comprises one of home office, manufacturing, non-manufacturing, and educational.

22. A computerized method in accordance with claim 21, wherein:
in the event of an entry of said non-manufacturing user input, a building type user input may be selected from one of: school; supermarket or grocery store; restaurant; hospital; doctor or dentist office; hotel or motel; retail store; professional or administrative office; social space; police or fire department; place of religious worship; post office or copy center; dry cleaners, laundromat or beauty parlor; auto service or gas station; and warehouse or storage facility; and
per worker electricity and fuel usage corresponding to a selected building type is determined, at least in part, from historical energy consumption survey data.

23. A computerized method in accordance with claim 21, wherein:
in the event of an entry of said manufacturing user input, a manufacturing sector user input may be selected from one of: food; beverage and tobacco products; textile mills; textile product mills; apparel; leather products; wood products; paper; printing-related support; petroleum and coal products; chemicals; plastics and rubber products; nonmetallic mineral products; primary metals; fabricated metal products; machinery; computer and electronic products; electrical equipment; transportation equipment; furniture and related products; and miscellaneous products; and
at least one of total fuel consumption, per worker fuel consumption, total electricity consumption, and total natural gas consumption corresponding to a selected manufacturing sector is determined, at least in part, based on a historical census data for the selected manufacturing sector and geographic location data.

24. A computerized method in accordance with claim 23, wherein:
industry specific user inputs corresponding to said manufacturing user inputs are made available;
the at least one of the total fuel consumption, the per worker fuel consumption, the total electricity consumption, and the total natural gas consumption corresponding to the selected manufacturing sector is refined based on said industry specific user inputs.

25. A computerized method in accordance with claim 21, wherein:
in the event of an entry of said educational user input, an educational capacity user input may be selected from one of a teacher input or a student input and a facility type may be selected from one of kindergarten, elementary school, middle school, high school, or college.

26. A computerized method in accordance with claim 25, wherein:
in determining overall greenhouse gas emissions and fuel usage corresponding to said educational user input, different multiplication factors are assigned based on whether the teacher user input or the student user input are selected;
a first multiplication factor for said teacher user input and said college user input is based on a per worker value;
a second multiplication factor for said kindergarten user input, said elementary school user input, said middle school user input, and said high school user input is based on a per worker and student value, such that the overall greenhouse gas emissions and fuel usage per kindergarten, elementary school, middle school or high school student for a selected facility type will be less than the overall greenhouse gas emissions and fuel usage per teacher or college student in said selected facility type.

27. A computerized method in accordance with claim 25, wherein said educational user inputs are correlated with historical data for similar educational buildings in a corresponding census division or zip code.

28. A computerized method in accordance with claim 25, wherein additional user inputs comprise at least one of city, state, zip code, square footage, date of construction, number of floors, human capacity and usage, occupation, hours of operation, exterior materials, lighting, heating equipment type, space heating equipment type, cooling equipment type, space cooling equipment type, heating fuel, water heater type, water heater fuel, average monthly fuel usage, fuel usage per month, fuel payment history, electricity usage per month, and average electricity usage per month.

29. A computerized method in accordance with claim 4, wherein said user inputs for said shopping category comprise at least one of: food and beverage purchase information; household item purchase information; residence information; apparel purchase information; service purchase information; transportation and vehicle usage information; healthcare information; entertainment purchase information; personal care product and service purchase information; reading material purchase information; educational information; tobacco products and smoking supply purchase information; miscellaneous purchase information; and personal insurance and pension information.

30. A computerized method in accordance with claim 29, further comprising:
correlating said user inputs with historical survey data and reference categories for determination of corresponding multiplication factors;
multiplying dollars spent for each of said user inputs with a corresponding multiplication factor to determine corresponding greenhouse gas emissions and energy usage for each of said user inputs.

31. A computerized method in accordance with claim 1, wherein said energy usage is converted to greenhouse gas emissions using historical sub-regional grid-level electricity greenhouse gas content data.

32. A computerized method in accordance with claim 1, wherein said historic data comprises at least one of government data, private data, public energy study data, and data contained in databases administered by universities and government agencies.

33. A computerized method in accordance with claim 32, wherein said government data comprises data from at least one of U.S. Department of Energy, U.S. Environmental Protection Agency, U.S. Department of Labor, U.S. Department of Commerce, U.S. Department of Transportation, U.S. Census Bureau, and data from databases maintained by other government agencies.

34. A computerized method in accordance with claim 1, further comprising:
prompting said end user for additional user inputs based on selected user inputs to further refine the overall greenhouse gas emissions and energy usage.

35. A computerized method in accordance with claim 1 further comprising:
calculating a specific impact of a particular user action on the end user's overall greenhouse gas emissions and energy usage;
wherein said impact is presented in the form of at least one of energy savings or increase, greenhouse gas reduction or increase, cost savings or increase, and resource savings or increase for the particular user action.

36. A computerized method in accordance with claim 35, further comprising:
providing comparisons of said impact between alternate choices for a particular user action.

37. A computerized method in accordance with claim 35, wherein said overall greenhouse gas emissions and energy usage for said end user is updated automatically upon entry of said particular user action.

38. A computerized method in accordance with claim 35, further comprising:
providing at least one of an Internet application or a downloadable application for at least one of: (a) said determining of said overall greenhouse gas emissions and energy usage for said end user; and (b) said calculating of said specific impact of a particular user action or purchase; and
providing a customizable user interface for at least one of said Internet application and said downloadable application.

39. A computerized method in accordance with claim 38, further comprising providing a link to at least one of selected individuals or selected companies for comparison of overall greenhouse gas emissions and energy usage.

40. A computerized method in accordance with claim 39, further comprising providing at least one of: updates on said selected individuals or companies greenhouse gas emissions and energy usage status; real-time chats with said selected individuals or individuals at said selected companies; energy saving product and service updates; energy and cost savings planning information; fuel cost updates from various regional suppliers, informational material regarding energy savings and reduction of greenhouse gas emissions; community event information; online shopping for recommended products and services; displays relating to said overall greenhouse gas emissions and energy usage and subcategories of said overall greenhouse gas emissions and energy usage; access to custom product and action recommendations tailored to said end user based on said user inputs; energy saving actions recommended based on actions taken by users with similar demographic characteristics; and energy savings actions prioritized based on payback period and discount rate.

41. A computerized method in accordance with claim 1, further comprising:
providing a virtual world environment for said end user based on said user inputs; and
calculating a specific impact of a particular user action taken in the virtual world environment on the end user's overall greenhouse gas emissions and energy usage.

42. A computerized method in accordance with claim 41, further comprising at least one of:
providing guidance and recommendations to said end user for reducing said overall greenhouse gas emissions and energy usage in said virtual world environment;
enabling virtual contests between individuals in said virtual world for reduction of said overall greenhouse gas emissions and energy usage in said virtual world environment; and
enabling a multi-user virtual game where points are awarded based on reduction of said overall greenhouse gas emissions and energy usage in said virtual world environment.

43. A system for determining greenhouse gas emissions and energy usage, comprising:
a user interface adapted to accept user inputs specific to an end user;
a communications link to at least one database;
processing means adapted to accept said user inputs from said user interface and to access said at least one database via said communications link in order to correlate one or more of said user inputs with at least one of historic data and modeled characteristics pertaining to greenhouse gas emissions and energy usage contained in said at least one database to obtain at least one of greenhouse gas emissions and energy usage corresponding to said one or more of said user inputs; and
wherein said processing means determines an overall greenhouse gas emissions and energy usage for said end user based on said greenhouse emissions and energy usage corresponding to said one or more of said user inputs.
